(19) United States
(12) Patent Application Publication
(10) Pub. No.: US 2022/0351633 A1
(43) Pub. Date: Nov. 3, 2022

(54) LEARNER ENGAGEMENT ENGINE

(71) Applicant: Pearson Education, Inc., Bloomington, MN (US)

(72) Inventors: Stephen Carroll, Bloomington, MN (US); Brian Dailey, Bloomington, MN (US); Saxena Ritu, Bloomington, MN (US); Alex Johnson, Bloomington, MN (US); Zach Kulpa, Bloomington, MN (US); Albert Christy, Bloomington, MN (US)

(21) Appl. No.: 17/633,463

(22) PCT Filed: Aug. 12, 2020
(86) PCT No.: PCT/US2020/045966

§ 371 Date: Feb. 7, 2022

Related U.S. Application Data
(60) Provisional application No. 62/885,757, filed on Aug. 12, 2019.

(51) Int. Cl. G09B 5/06

(52) U.S. Cl. CPC G09B 5/06; G09B 7/00

(57) ABSTRACT

A learner engagement engine provides a unique way to track and measure a learner's engagement across a plurality of different learning resources. In preferred embodiments, the learning engagement engine measures learner's engagement activities at the most detailed level (such as at a paragraph level, instead of a chapter or book level). This allows the learner engagement engine to easily aggregate learner activities, even when a course structure or context are changed during the course.

### FIELD OF THE INVENTION

This disclosure relates to the field of systems and methods configured to allow learner analytics to be efficiently tracked even when a course hierarchy and/or structure are changed after the course has started.

### SUMMARY OF THE INVENTION

The present invention provides systems and methods comprising one or more server hardware computing devices or client hardware computing devices, communicatively coupled to a network, and each comprising at least one processor executing specific computer-executable instructions within a memory.

An embodiment of the present invention allows analytics on measurements to work with an original table of contents (TOC) and an updated TOC. An electronic education platform may generate the original TOC for a course. The original TOC may comprise a first original assignment and a second original assignment. The first original assignment may comprise a first plurality of learning resources and the second original assignment may comprise a second plurality of learning resources.

A learner engagement engine may measure a plurality of student engagement activities, such as reading time, for the first plurality of learning resources and for the second plurality of learning resources. The learner engagement engine may aggregate the measurements in the plurality of student engagement activities that are in the first original assignment to determine a total amount of time spent on the first original assignment. As an example, the reading time for a particular student may be 1.1, 1.2 and 1.3 hours reading corresponding chapters 1, 2 and 3 as the first original assignment and 1.4 hours for reading chapter 4 as the second original assignment. The aggregated measurements may be graphically displayed to the teacher. The teacher may, at any desired time, update the TOC. As an example, the teacher may wish to move reading chapter 3 from the first original assignment to the second original assignment, thereby creating a first updated assignment of reading chapters 1 and 2 and a second updated assignment of reading chapters 3 and 4. Of course, other types of changes may be made to the assignments, such as adding and deleting other learning resources from the assignments.

The learner engagement engine may aggregate the measurements in the plurality of student engagement activities that are in the first updated assignment to determine a total amount of time spent on the first updated assignment. The learner engagement engine may also aggregate the measurements in the plurality of student engagement activities that are in the second updated assignment to determine a total amount of time spent on the second updated assignment. It should be noted that measurements of student activities measured while the original TOC was active may be used to calculate various desired analytics for the updated TOC. The learner engagement engine may graphically display the total amount of time spent on the first updated assignment and the total amount of time spent on the second updated assignment, even though the measurements were taken before the TOC was updated. The above features and advantages of the present invention will be better understood from the following detailed description taken in conjunction with the accompanying drawings.

### BRIEF DESCRIPTION OF THE DRAWINGS

FIG. 1 illustrates a system level block diagram for a non-limiting example of a distributed computing environment that may be used in practicing the invention.

FIG. 2 illustrates a system level block diagram for an illustrative computer system that may be used in practicing the invention.

FIG. 3 illustrates a block diagram of a learner engagement engine determining various engagement features that describe a learner's interaction with a content.

FIGS. 4 and 5 illustrate possible user interfaces that display an engagement aggregation of when a selected group of students, such as a class, are reading.

FIGS. 6 and 7 illustrate a user interface displaying an engagement aggregation for the lead time before starting assignments for each student in a plurality of students.

FIG. 8 illustrates a user interface displaying an engagement aggregation for the lead time before starting assignments by each student in a plurality of students.

FIGS. 9A and 9B illustrates a user interface displaying graphical information regarding an engagement of a student.

FIGS. 10-12 illustrate user interfaces displaying an engagement aggregation for time spent reading for a plurality of students.

FIGS. 13A and 13B illustrates a user interface displaying a temporal engagement aggregation by a plurality of students.

FIG. 14 illustrates a block diagram of a learner content context determined from hierarchical relationships of learning resources.

FIG. 15 illustrates a baseline use case of an embodiment of the present invention.

FIG. 16 illustrates an extended dynamic use case of an embodiment of the present invention.

FIG. 17 illustrates a display that may be presented to a teacher, using a client device, to inform the teacher on various analytics regarding the students in the class.

FIG. 18 illustrates a pop-up from the display in FIG. 28 that breaks the analytics down by student.

FIG. 19 illustrates a display that may be presented to a teacher, using a client device, to inform the teacher on the progress made by individual students.

FIG. 20 illustrates a display that may be presented to a teacher, using a client device, to inform the teacher on the progress made on individual assignments.

FIGS. 21-22 illustrates a display that may be presented to a teacher, using a client device, to inform the teacher on the progress made by the students in the class.

FIG. 23 illustrates a display from the learner engagement engine that supports multiple models and median time spent on a given assessment by class or total time spent on a given assessment by a given student.

FIG. 24 illustrates possible user interfaces that display an engagement aggregation of idle time while reading by a selected group of students.

FIG. 25 illustrates possible user interfaces that display an engagement aggregation of idle time while reading by a selected group of students.

FIG. 26 illustrates possible user interfaces that display an engagement aggregation of idle time while reading by a selected group of students.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Research with instructors has suggested that students are not only challenged with the academic nature of learning (understanding knowledge) but often more importantly they are challenged by how to be most productive by developing consistent learning behaviors. Instruction and data associated with such learning behaviors, provided directly to the instructor may empower instructors to make a difference through discussion and intervention with regards to students' learning behaviors.

The disclosed embodiments include a learner engagement engine which creates a platform for the manner in which activity is tracked across dynamic content. For example the disclosed embodiments may create a platform, in near real time, for learning resources, structures, and/or use cases that are changed by instructors, so that learners activity analytics can be leveraged in the correct context within their learning experience. This approach may represent an improvement to current approaches, which focus on dedicated solutions (e.g., date, code, APIs) per product model. Instead the disclosed embodiments offer a micro-services approach where availability of activity analytics is across product model and across contexts (such as book structure and assignment structure) at the same time.

In the disclosed embodiments, when an instantiation of a product is first created, the product system will seed the initial structure of the content including any areas where the same content is mapped to multiple structures, as described in more detail below (e.g. Chapter Section 1.1 is mapped to: the Book, the Chapter, a given assignment, and 1 to many learning objectives). The relationship between the structures and the objects is unique per instantiation and will dictate the aggregations during runtime use cases. As the student interacts with a given learning resource (chapter, page, video, question, interactive, etc.) their activity is tracked individually on the given object, both point in time and temporally (view, load, unload, time spent, session). When an associated product (e.g., software calling from an API) makes a call to display various activity analytics in the user experience, the current state of the hierarchy and the relationship of the learning resources in the hierarchy dictate and calculate a value associated with given metrics. As a result, when an instructor changes an assignment structure after there has already been activity by the student or a curriculum designer changes a learning objective map after there has already been activity, the new structures will calculate activity analytics based on the new context.

The disclosed embodiments may be differentiated from existing technology because of its ability to re-use the same data aggregations, system, & APIs to support activity analytics where content is structured in multiple different hierarchies at the same time (e.g., reporting on activity analytics in book structure, assignment structure, and learning objective structure from single stream of student activity data).

In summary, the disclosed system was developed in part to address the continuous need for tracking activity analytics across a corpus of content (regardless of product) and therefore was architected in a manner that it treats all content as objects that can fit into one-to-many hierarchical structures. This generic approach to content as objects means that the approach can be used for any digital content-based product. For example, using the disclosed embodiments, instructors may view how many students in a class have done less than 35% of the questions that have been assigned within the last 5 assignments, allowing the instructor to tailor their intervention with those students to completing their homework. In another example, the instructor may understand the number of pages a student has viewed out of the total pages of content that have been assigned, thereby allowing the instructor to make suggestions around material usage when intervening with any given student. In a third example, an instructor may view at a glance which assignable units (assessments) in an assignment are flagged with low activity and can quickly get to those specific students that have not done the work in order to improve the students' performance.

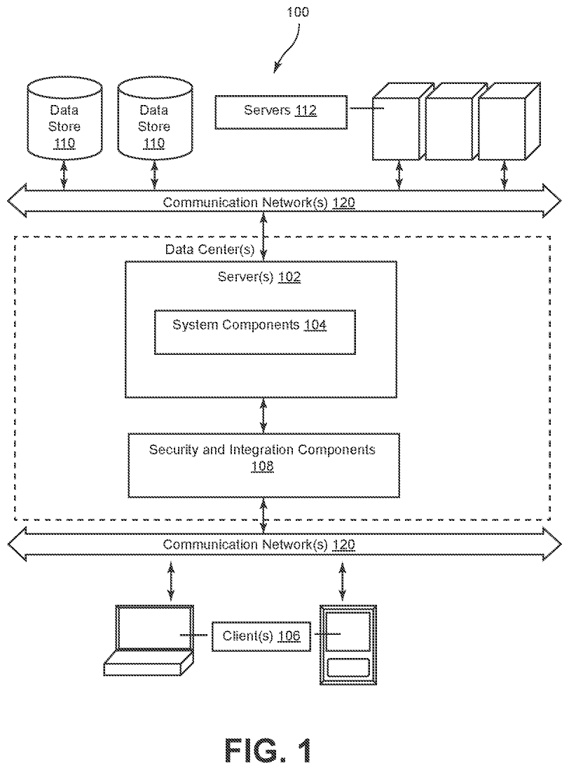

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

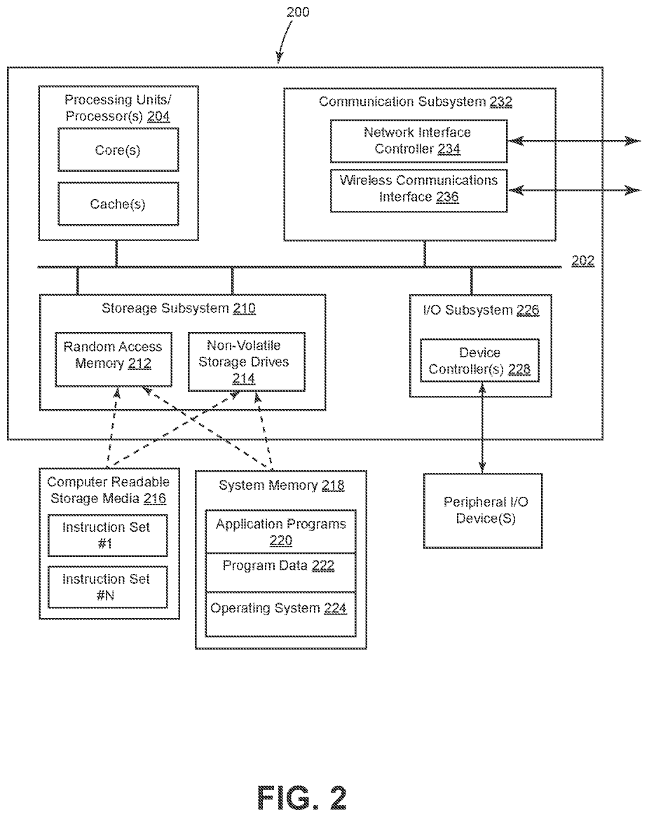

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users. As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure. In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216. System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc. System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204. System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214. Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210. Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, solid state drives or ROM, DVD disks, digital video tape, and the like or combinations thereof. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200. The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible.

The learner engagement engine may monitor and measure, by a learner engagement engine, a plurality of student engagement activities for a plurality of learning resources. For purposes of the present invention, engagement scoring refers to building an index of engagement scores, rooted in student success models, for both individual students as well as cohorts of student that tracks their level of engagement across multiple aggregations. As non-limiting examples, cohort contexts may include course section, cross course section, institution(s) and custom (e.g. student athletes, co-requisite participants, etc.) As non-limiting examples, academic contexts may include discipline, topic/concepts and learning objectives. As non-limiting examples, behavioral contexts may include activity patterns, learning resource type and stakes state.

Engagement scoring in context and in comparative may provide insights about learner behaviors such as how learner engagement varies from course to course; how learning engagement trends across the students full learning experience; how learning engagement may shift from particular academic areas of interest or proclivity to certain types of learning resources; temporal ranges that learners prefer to engage and how their score varies; and how engagement scores vary between importance of the work they are doing, such as high stakes or low stakes assessments.

Student behavior tracking feature vectors may be researched as part of a model. While any desired type of student engagement activity may be monitored and measured, as non-limiting examples, the time spent (average, median, total, comparative) with a learning resource (preferably the learning resource is defined at a very detailed or low level (such as a particular paragraph or image in a book), object views (total, min, max, comparative), time & view aggregations at variable contexts (e.g. book, chapter, section, learning objective, interactive, etc.), engagement weighting by activity type (reading vs. practice vs. quiz vs. test vs. interactive vs. social, etc.) and lead time—temporal distances between assigned and due contexts.

The present invention may be used to predict a level of engagement necessary to be successful in a given course. Predicting engagement may use successful outcomes planning. In other words, the invention may take a best ball approach to learn from successful student behaviors coupled with learning design to create personalized models of how often and what types of engagement activities learners should be employing in order to be successful in their academic journey. Thus, the present invention may be used to provide guidance to students based on the engagement activities of past successful students.

As a non-limiting example, the learner engagement engine may recommend study hours and days of the week based on historical trending and estimated work times to support learners owning their learning experience by planning ahead. As another non-limiting example, the learner engagement engine may transmit study session strategy recommendations to the teacher or the students to help learners chunk their time in a meaningful way. As another non-limiting example, the learner engagement engine may transmit a lead time analysis graphical representation to guide the teacher or the student on how soon before an assignment is due should the student start working on the assignment.

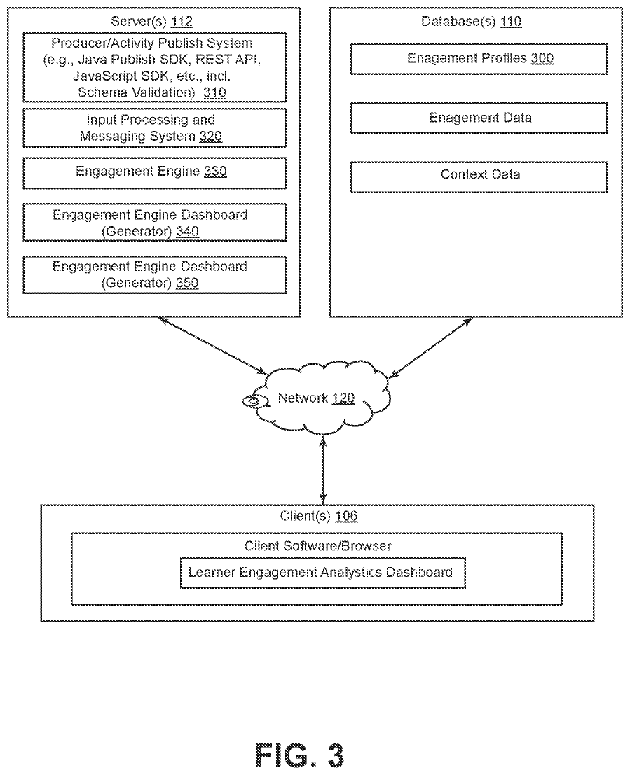

FIG. 3 illustrates a block diagram of the disclosed system. As disclosed in more detail below, the disclosed system may provide a log of a user's engagement with the system, and in some embodiments, a user's navigation through a designated path. The system may be configured to log events that were involved during the user's navigation. These events, navigation, and other engagement may allow the disclosed system to generate one or more activity engagement profiles 300 (e.g., for the user, for a class, for a course, defining parameters associated with a software or a user, etc.). In some embodiments, these activity engagement profiles 300 may be researched and updated in real time. In some embodiments, the disclosed system may learn over time (e.g., model creation, machine learning, etc.) about the individual user or the software applications used by the user to personalize what engagement is productive for them.

In some disclosed embodiments, a system administrator (programmer, instructor, etc.) may create a dedicated library of Software Development Kits (SDKs) that consumers may select to optimize their implementation. To accomplish this, the disclosed system may include one or more producer system software modules 310 configured to receive data input into the system. These producer system software modules 310 may include components configured to publish various activities generated from user interactions. Non-limiting examples may include a Java publishing software development kit (SDK), a REST API, a JavaScript SDK, etc. In some embodiments, each of these may include schema validation before execution. Some embodiments may include an input processing and messaging system 320, which may or may not be integrated, associated with, or used in conjunction with the producer system software modules 310. In some embodiments, the producer system software modules 310 may include an e-text/course connect publisher, which may publish, as non-limiting examples: learning resource messages; generic object relationship messages; course section to context messages; course section enrollment messages; and activity (e.g., UserLoadsContent/UserUnloadsContent, described in more detail below). In some embodiments, the published data may be queued, consumed, published, persisted, read, and processed by a learner engagement engine 330, and read for display on the learner engagement engine analytics dashboard, as described below. In some embodiments, a User Interface (UI or GUI) Document Object Model (DOM) events within the UI may be used to capture the user engagement by logging or otherwise recording DOM events input into the GUI as they interact throughout the content, as described in more detail below. In some disclosed embodiments, the system may be configured to classify event data, such as start, stop, and/or null categories (events that are not indicative of user activity, such as dynamic content loads). In some embodiments, a system administrator, or logic within the system itself may classify events into engagement weighting categories (e.g., mouseover<scroll<click<etc.). In some embodiments, the system may capture, generate and populate within the log associated with the DOM, the date and/or timestamp of the user interaction, based on the established trigger categories. To capture the date timestamp and generate the log associated with the DOM, the system may be configured to start the log generation upon the user loading the page or other resource. In some embodiments, events may be logged upon a page or other resource being unloaded and at some temporal frequency. As a non-limiting example, described in more detail below, in some embodiments, the events associated with a resource may be logged every {n} seconds. To minimize loss in the event unload event may not reached due to system/idle degradation (e.g. every 30 seconds)

The system may be then be configured to read the log from the stream and/or store for batch processing. As a non-limiting example, if the instructions in the disclosed system log all events every 30 seconds then a queue would need to hold the events and process in parallel as they arrive in order to string together the activities within a specific page.

As described below, the disclosed system may use in stream aggregations to process student activity in near real time (NRT) so that engagement insights are as timely and accurate as possible for optimal real time decision making by students and instructors. The data from the stream described above may therefore be input into an input processing and messaging system 320, which may process the input data. As non-limiting examples, this input processing may include: data dedupe; simple time aggregation (e.g., aggregation of interaction with learning resources); content hierarchy time aggregation (e.g., aggregation for a book based on chapters in the book, sections within the chapters, content within the sections, etc., as described below); temporal/time period analytics (e.g., an analysis of user interactions, broken down by resources, assignments, learning objectives, time spent, etc., and/or using/eliminating idle time within activities, as described below); and deeper engagement insights (e.g., engagement broken down by activities or users, analysis of groups such as classes, identification, alerts, and intervention for students that are not actively engaged, etc., as described below, etc.). The disclosed system may further pass the log through an activity engagement processor, possibly associated with, or possibly the engagement engine 330.′

In some embodiments, the disclosed system may then pull in (e.g. select from data store 110) an engagement profile 300 that will allow a certain set of rules to be applied in calculating idle time. As a non-limiting example, if the timestamps indicate that there has been 20 seconds between start and stop, then system may then add 20 seconds to the user's time spent but if the start and stop indicates 45 seconds from one UI event to the next UI event and the profile indicates that a maximum of 30 seconds can be applied to time on task then the rule may dictate that only 30 seconds be added to the time spent and 15 seconds to the idle time spent. Idle time analysis will be described in greater detail herein. The system may then process multiple messages by stringing together UI event start/stop timestamps in order to ensure that the system is not missing any events (e.g., in a scenario where the system logs events every 30 seconds). The system may then process the completion and progression update events based on the definitions about productive engagement and calculating completion/progress from the UI activities strung together from logs, possibly as defined in engagement profiles 300. It should be noted that in some embodiments, completion DOM markers may need to be placed in the UI and the concept of scrolled into the view window/scrolled out of the view window trigger events sent to indicate a ‘reached end’ of targeted area achieved.

In some embodiments, the processed data may then be used as input into the engagement engine 330, which may include an engagement engine fact generator. The data generated by the engagement engine 330, as described herein, may be loaded into active memory for data logic to be performed on it, or may be stored (possibly via a batch layer) in long term memory, such as database 110. As additional data is generated and stored, the aggregated data may then be re-processed by the input processing components described above.

The processed and stored data may be utilized by additional services (e.g., additional software via API calls) within or associated with the system and additional composites and/or aggregations may be generated and stored in database 110. The composite/aggregated data may be displayed as part of a learning engagement engine analytics dashboard 340, which may include multiple UIs, as demonstrated and described below.

The disclosed system may run a utility to clear events that may have been opened, but not closed, referred to herein as a “pipeline pig” for user engagement events. In some embodiments, this utility may be run or otherwise executed hourly (or at a different interval frequency determined by the instructions in the software) to clean up any events that are still ‘open’. As each of the items in the queue are analyzed, if the learner has not had an subsequent event in the queue over the last hour (or other designated interval frequency) then the system may process any engagement time in the remaining event. In some embodiments, this interval frequency may be applied via a dynamic time spent based on a predicted estimate. In some embodiments, this interval frequency may be a personalized estimate. The system may then close out the events for the given learner, or other events in the queue.

In some embodiments, the system may use a session timeout listener to close out open events. In some embodiments, the system may query for session timeout events to be sent throughout the system and then correlate via learning resource ID what open load events should have an unload event dynamically generated.

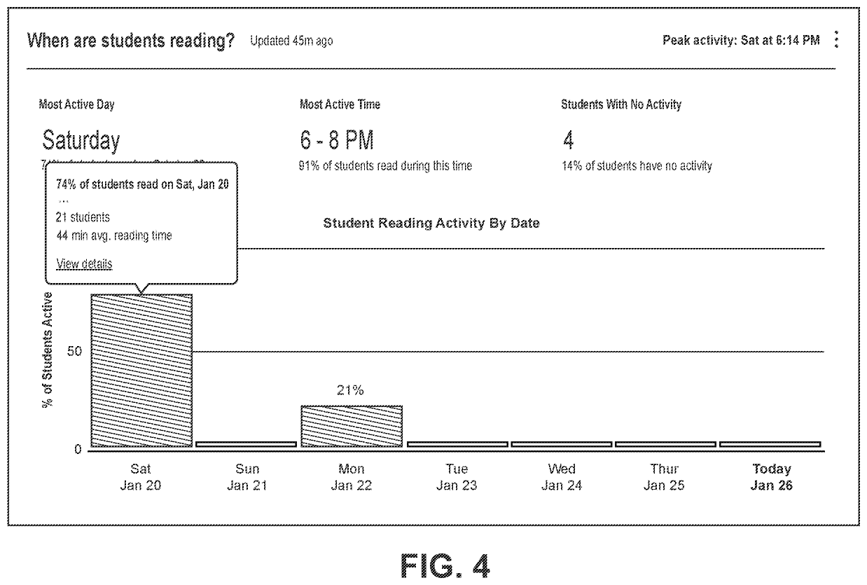

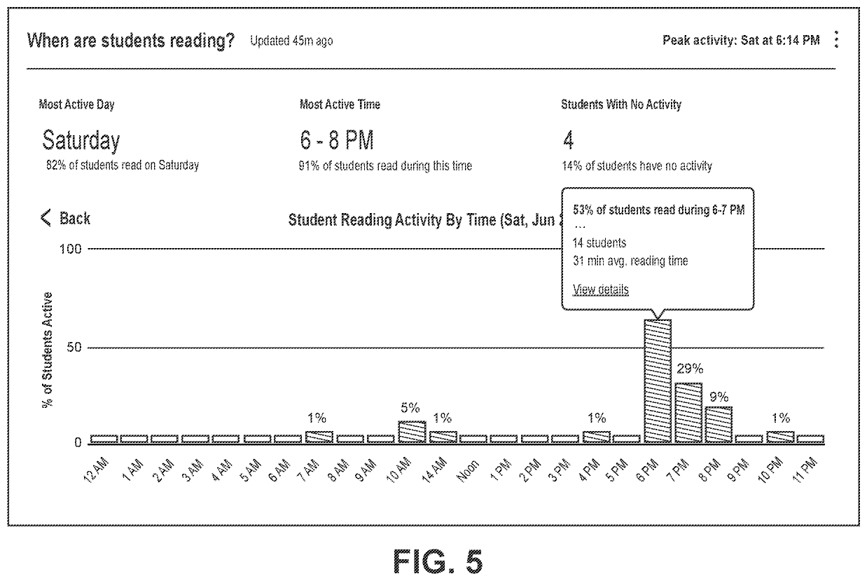

In FIGS. 4 and 5, temporal distributions may be tracked by bucketing student engagement activities in hourly distributions so that historical and/or trending visualizations and aggregations may be crafted. FIG. 4 illustrates a graphical representation of when students are engaged (reading in this case) by day. As seen in FIG. 4, the data displayed for users and their engagement with reading may include when students are reading. As non-limiting examples, this may include a most active day, a most active time, students that have no activity, and a percentage of students that are active on a particular day. In the non-limiting example in FIG. 4, a bar chart, showing student reading activity by date, may cross reference each day and the percentage of students who are active on that day. This data may further include the number of students that were active, the average reading time for students, as well as additional details. As seen in FIG. 4, the user interface may further include a peak activity date and time. FIG. 5 illustrates a graphical representation of when students are engaged (reading in this case) by hour of a day selected by the teacher. The data displayed to users may be analogous to the reading by day described above. As non-limiting examples, this may include the most active day and time and students that have no activity, as well as students that are active at a particular time. The bar chart may cross reference each hour and the percentage of students that are active at that hour. The data may further include the number of students that were active, the average reading time, and additional details.

Some embodiments may include a graphical representation of time spent by students. While any classifications may be used, in preferred embodiments the classifications of time spent by learning, assessment and non-academic related activities may be used. In some embodiments, the time spent against the same content in multiple contexts (learning objectives) may be aggregated and presented in a graphical representation.

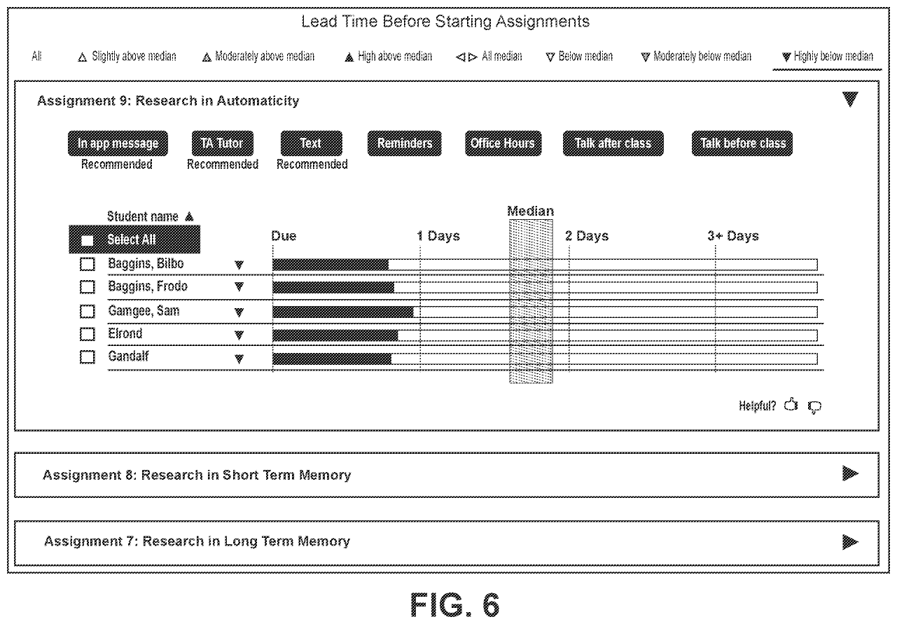

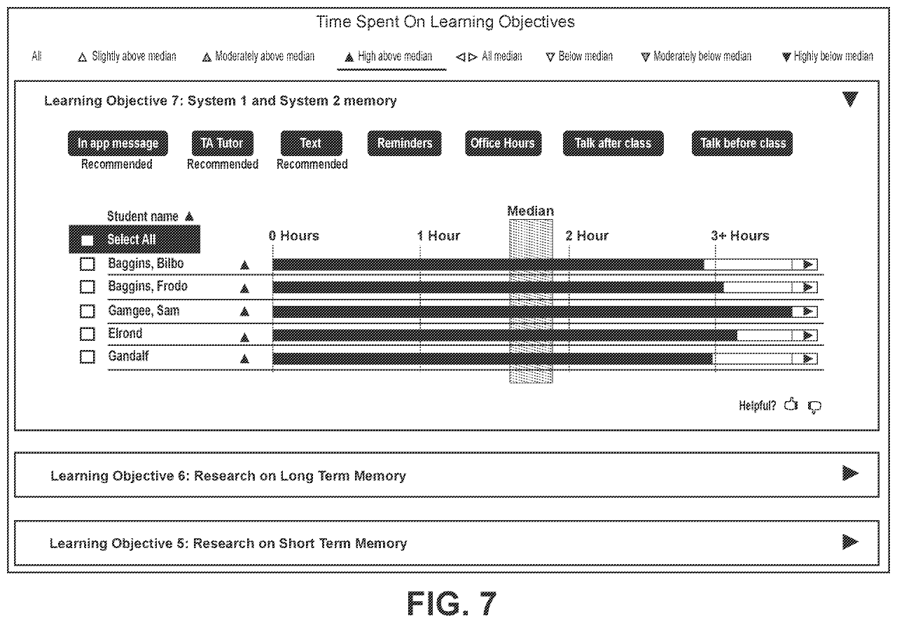

The figures include multiple graphical representations that may be transmitted to the client device of the teacher to inform the teacher how engaged the students are with the learning resources of the course. FIG. 6 is an example of graphical illustration of the lead time before starting assignments by student and time spent on learning objectives by student. An analysis of this lead time across groups of users, such as a class various sections of a class, may be used to generate recommendations regarding how much time students should allocate in preparation of various assignments or assessments.

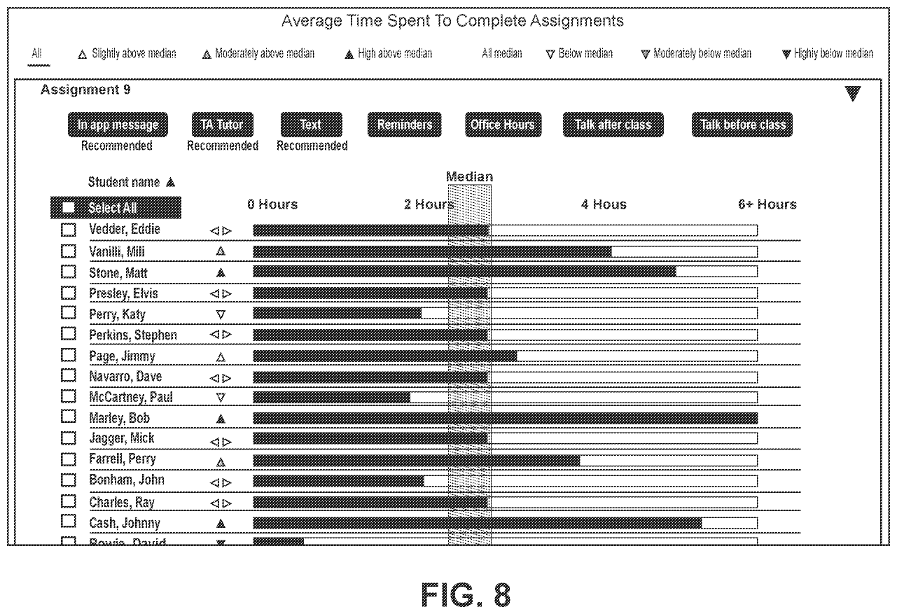

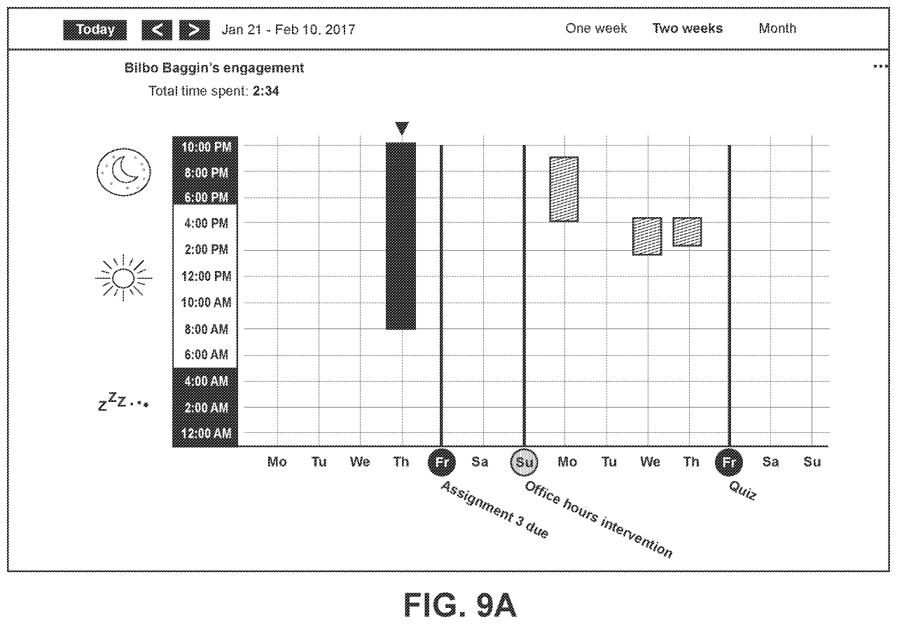

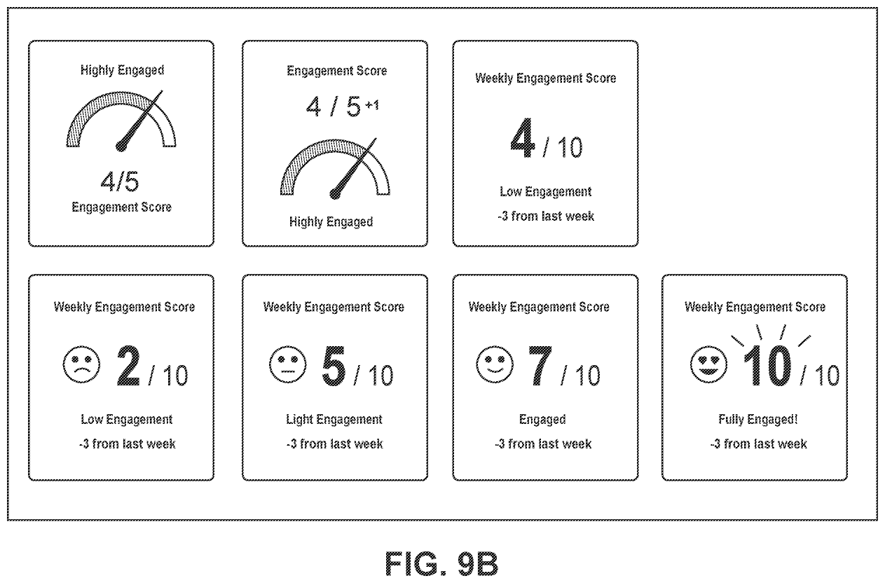

Some embodiments may include a graphical illustration of the time spent on learning objectives by student, further broken down by problem for a selected student (e.g., Gamgee, Sam). FIG. 8 is an example of graphical illustration of the average time spent to complete assignments by student. FIGS. 9A and 9B are examples of graphical illustrations of when and for how long a particular student (Bilbo Baggin) has spent with the learning resources for the course.

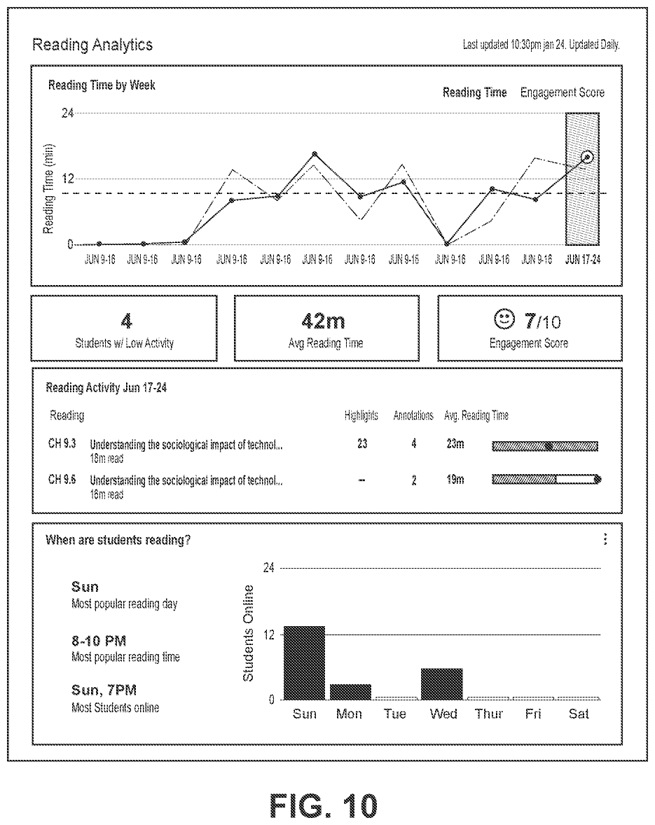

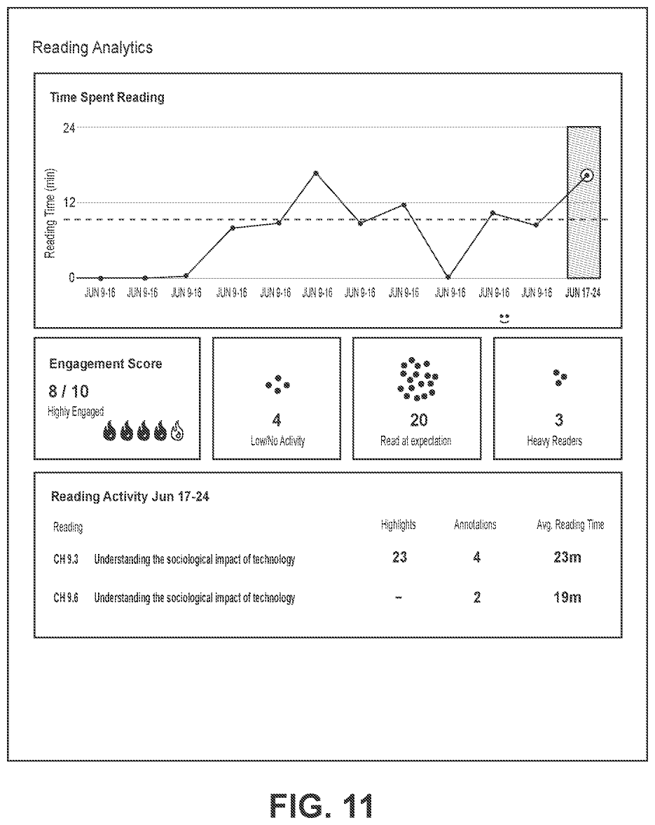

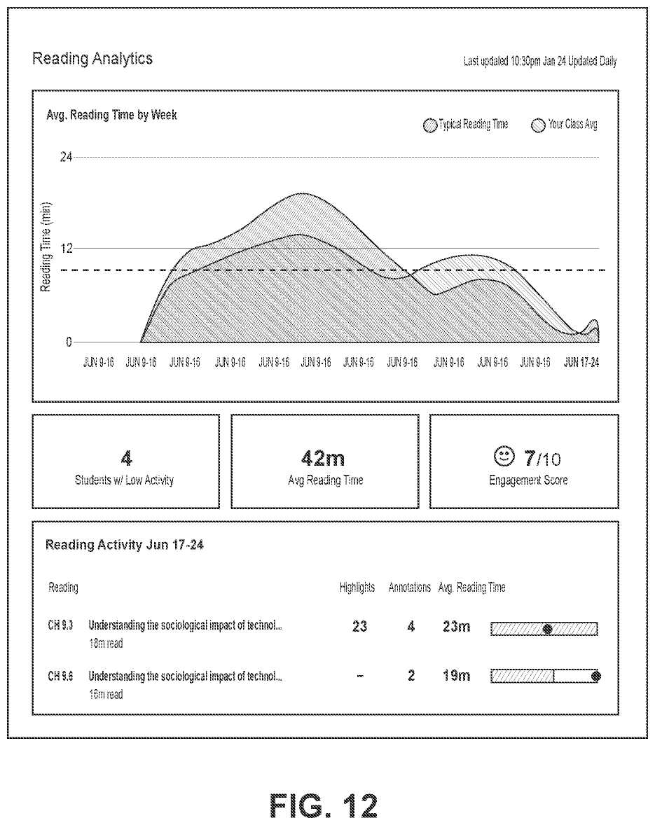

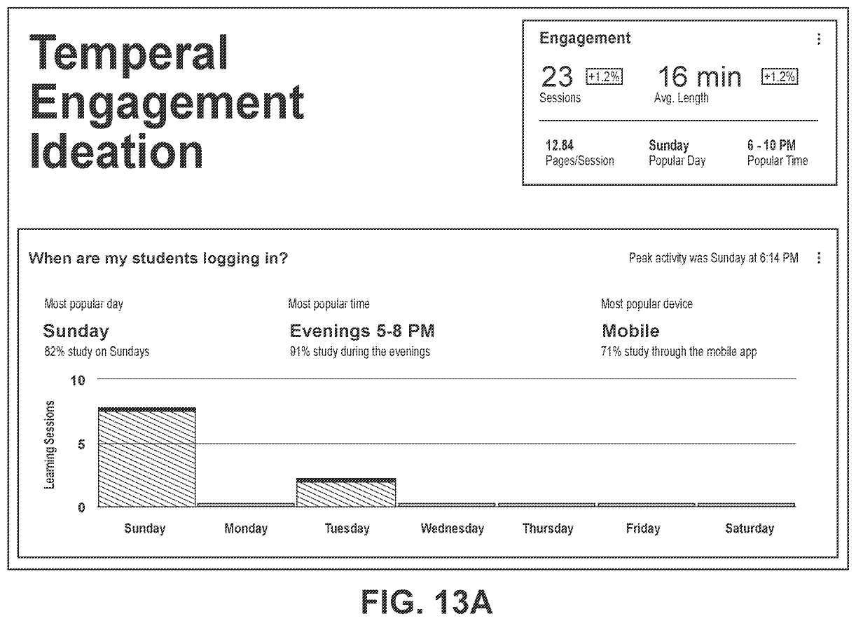

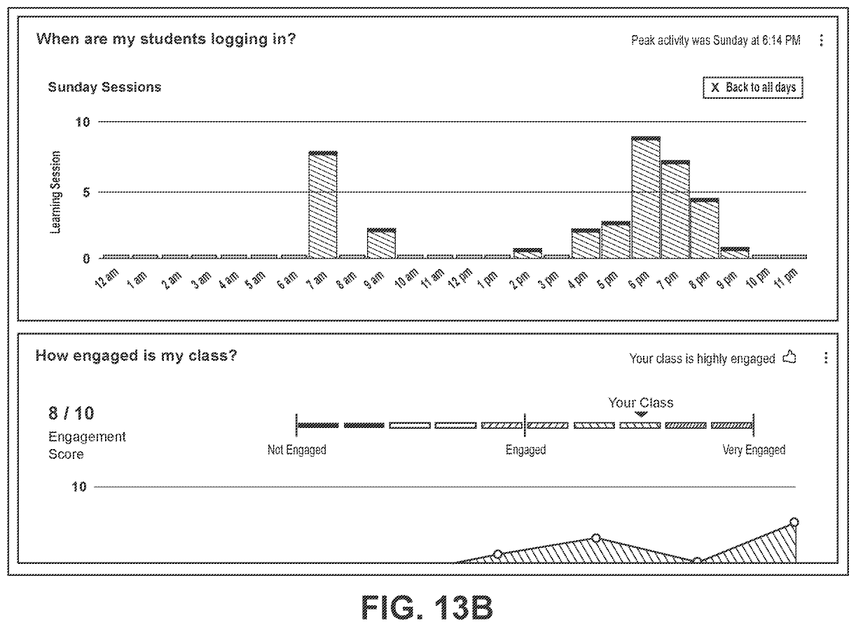

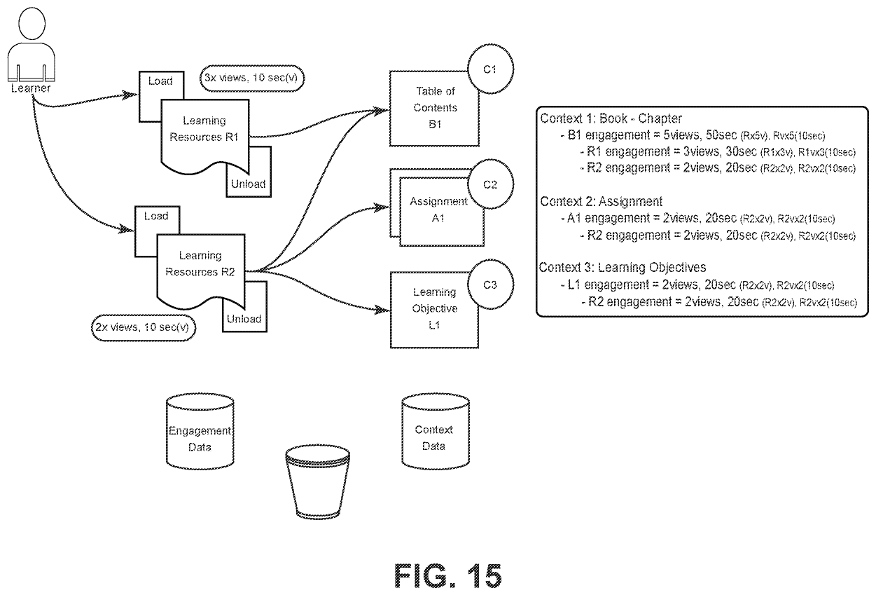

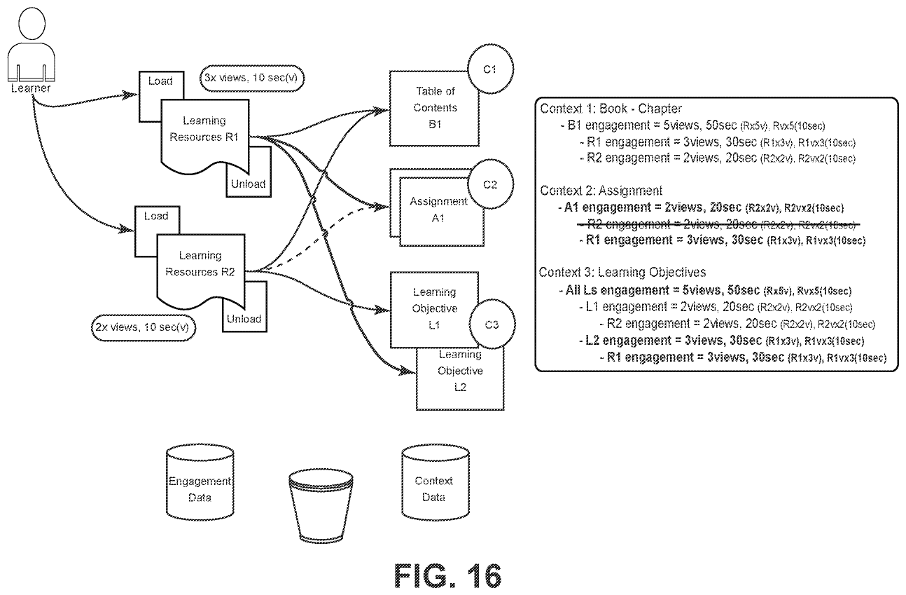

FIGS. 10 and 11 are examples of graphical illustration of reading analytics, such as the average reading time per week by the students. In FIG. 10 the data is broken out by assignment. FIG. 12 is an example of graphical illustration comparing the average reading time of students in a class verses an average typical reading time for students in other classes taking the same course. FIGS. 13A and 13B are examples of graphical illustrations of the temporal engagement of a student engaging the learning resources of the class. FIG. 15 illustrates a baseline use case of an embodiment of the present invention. FIG. 16 illustrates an extended dynamic use case of an embodiment of the present invention.

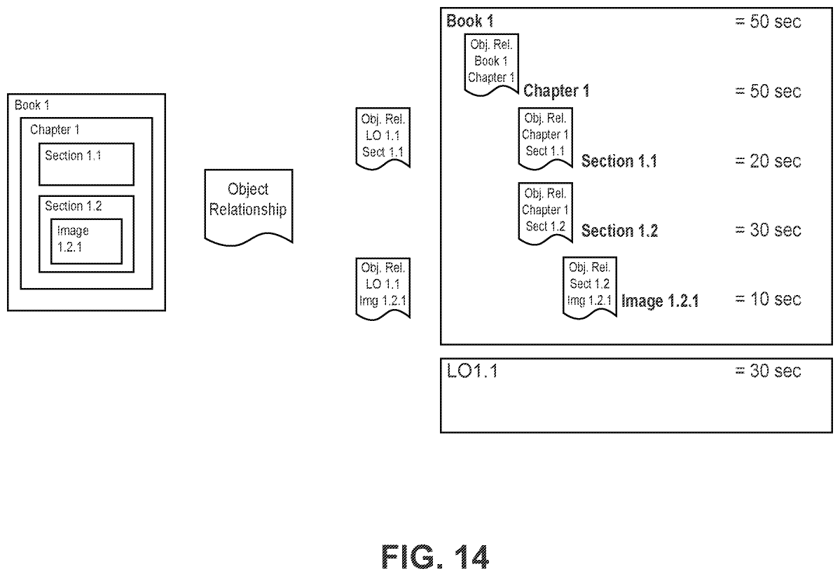

The non-limiting example embodiments in FIGS. 14-16 may represent an example of a learning resource (book), assignment and learning objectives. Learner engagement engine data powers the feature layers. Different product models may use the learner engagement engine data and context to layer on applicable business rules for their given product experience and development more intelligent behavioral insights and interventions for the customer. An example would be the low activity indicator for GLP Revel that alerts an instructor when a student has not completed 35% (business rule) or more of the assigned questions, thereby empowering the instructor to intervene manually or via email with the given student or a set of students that have been classified as ‘Low Activity’.

In these example embodiments, the engagement engine may generate and or analyze, from the engagement data, one or more features, and possibly intervention suggestions. As non-limiting examples, these features and/or intervention suggestions may include low activity reading, recommended study sessions, dynamic time on task, most engaging content, low activity assessing, student engagement scores, and progression on context.

Thus, FIGS. 14-16 illustrate possible system functionalities. As non-limiting examples, the system functionalities may be an individualized engagement service, a matrixed-content processing and dynamic context shifting. The individualized engagement services may provide a micro-service for every student so that engagement features can be used across multiple experiences where learning resources interact with the student. The matrixed-context processing system function may be used to track and aggregate the same student engagement activity consistently when those activities are done in multiple contexts, such as learning resources, assignments, and learning objectives all at the same time. The dynamic context shifting may be used to address real time content structure and hierarchy changes by consumers (instructors/teachers' ability to shift the time per learning resource(s) as the consumer changes the configuration of the TOC). As noted above, the disclosed system may include a learner engagement engine 330 determining various engagement features that describe a learner's interaction with a content. As a non-limiting example, a user may load and/or unload content, and the learner engagement engine may analyze the loaded or unloaded content to determine various features related to the user interaction based on the loading or unloading of content. As a non-limiting example, in some embodiments, the learner engagement engine 330 may be able to determine a time on task for users, resource views by users, last activities of users, various comparatives, content usage by users, and progression through the content and through a learning program. In some embodiments, the output of such analysis (e.g., features determined) by the learner engagement engine 330 may include learning sessions, an engagement index for one or more users, rankings of one or more users, user comprehension, time spent on various objectives for each user, focus of users and interactions, idle time of the users, estimations of various calculations, and planning for future interactions.

FIG. 14 illustrates block diagrams of a learner content context determined from hierarchical relationships of learning resources. As a non-limiting example, FIG. 14 demonstrates the hierarchical relationships of learning resources, and how these hierarchical relationships are used to determine, identify, and/or generate a learner content context. As non-limiting examples, relationships may be identified or structured for a book, a chapter of a book, a section, presentation, slide, image within the chapter or section, a question associated with the chapter or section, a question part associated with the question (or chapter, section, etc.), a video, interactive article, web page, dashboard, learning objective, or topic associated with the section, chapter, book, etc., and so forth.

FIG. 15 illustrates a non-limiting example of the object relationship. In this example, a first book, Book 1, may include several chapters, including Chapter 1, Chapter 1 may further include Section 1.1 and Section 1.2, and Section 1.2 may include image 1.2.1. An object relationship may therefore exist between Book 1 and Chapter 1, between Chapter 1 and Section 1.1, between Chapter 1 and Section 1.2, and between Section 1.2 and Image 1.2.1.

As further analyzed below, the breakdown of these relationships may be used to determine the user interaction for various objects, which may, for example, “roll up” to a parent object. As a non-limiting example, regarding Section 1.2, a user may interact with Image 1.2.1 for 10 seconds, and with Section 1.2 for a total of 30 seconds (i.e., 10 seconds interacting with Image 1.2.1, and 20 seconds interacting with parts of Section 1.2 other than Image 1.21). Regarding chapter 1, a user may interact with section 1.2 for 30 seconds, as described above, and may interact with Section 1.1 for 20 seconds, so that the user has interacted with chapter 1 for 50 seconds. As a result, in this example, the user may have interacted with Book 1 for a total of 50 seconds.

FIG. 16 is a non-limiting example of object relationships as they relate to learning objectives. Using the details from the non-limiting example above, object relationships for learning objectives may be associated with each of the objects and object relationships. As non-limiting examples, the disclosed system may include learning objective object relationships, wherein a learning objective object (e.g., learning objective 1.1) is associated with one or more objects (e.g., Section 1.1 and/or Image 1.2.1). Using these relationships, the disclosed system may determine user interaction time based for learning objectives according to the interaction with the component parts of the learning objectives. As a non-limiting example based on the example above, the system may determine that a user has spent a total of 30 seconds on learning objective 1.1, because the user spent 20 seconds on section 1.1, and 10 seconds on image 1.2.1, both of which are associated with learning objective 1.1, so that the total time spent on that learning objective 1 would be determined to be 30 seconds.

FIGS. 15 and 16 illustrate a process of dynamic context shifting, while allowing engagement aggregations to be updated in (near) real time. In some embodiments disclosed herein (such as that demonstrated in FIGS. 15 and 16), the learning resource may represents the most atomic level object the learner might interact with. Examples may include a page, a question, a video, an image, an interactive element, a paragraph, etc. In these embodiments, a context may represent the relationship between nodes in a given content structure that makes up the user's learning experience. Contexts can be hierarchical or graphed in nature. Contexts in advance, and can have their relationships modified in real time.

Some embodiments may include context and relationship messages. As non-limiting examples, these context and relationship messages may include details related to: the user; the course; enrollment; learning objectives; ⋅learning resources; entity relationships ⋅(i.e., generalized relationship records used for defining the hierarchy of any aggregations to be performed by the engagement engine 330). Some embodiments may include activity messages, including UserLoadsContent, and UserUnloadsContent messages and/or variables. In these embodiments, loading and unloading of learning resources may represents learners' engagement activity on the atomic resources. Each activity tracks the number of views, the time spent on the atomic resource and the navigational details.

FIG. 15 demonstrates how one or more engagement aggregators may aggregate the total engagement time for each of the learning resources assigned to a specific aggregator. As a non-limiting example, learning resource R1 and R2 may be loaded and unloaded by the user. As noted above, the user interaction (time) for each of the accessed learning resources may be determined by a load time and an unload time for each learning resource. After determining the total interaction time for each of the learning resources based on load and unload times, one or more aggregators may then aggregate the interaction time according to mappings of the learning resources to assignments, learning objectives, etc. For example, these learning resources R1 and R2 may be mapped to a book and a specific chapter in a book, within a syllabus or table of contents (TOC), so that the aggregators may determine interaction time for the chapter (and book, according to the defined relationships described above) based on the aggregation of the interaction times with learning resource R1 and R2, which are mapped to the chapter and/or book.

In another example, learning resource R2 may be mapped to learning objective L1 and assignment A1, so that when learning resource R2 is unloaded, and the interaction time determined, the aggregator aggregates the interaction time and assigns/maps it to assignment A1 and learning objective L1. Thus, in a non-limiting example baseline use case, editorial teams may create a product structure with three different contexts (e.g., book, assignment, learning objectives). A learner may then engage in the atomic level objects that map differently in each of the three contexts. The learner engagement engine may aggregate activity differently for each context for product experience to consume.

FIG. 16 however, demonstrates that these mappings may be updated or otherwise changed at any time, in real time, or “on the fly,” to reassign learning resources to different assignments or learning objectives. The aggregators may likewise update the aggregations of the interaction time for these learning resources, so that the aggregations reflect the changes in mappings. Expanding on the example above, the mappings may be updated so that learning resource R1 is mapped to assignment A1 and to learning objective L2. In response, the engagement aggregators may be updated to aggregate engagement times for both learning resource R1 and learning resource R2 when generating the aggregation of engagement times for assignment 1, so that when learning resource R1 and learning resource R2 are unloaded, the engagement aggregators may calculate the total engagement time for assignment A1. Similarly, when learning resource R1 is unloaded, the engagement aggregators may calculate the engagement time for learning objective L2, using the engagement time for learning resource L1. FIG. 16 therefore represents an extended, dynamic use case; wherein an editorial team adds an additional learning objective to the title and publishes, in real time as part ol a live plan feature; the instructor changes the contents ol assignment A1 to contain a different learning resource (R2 removed, R1 added); all ol these changes are made after the student has already engaged with the atomic resources that have been remapped or newly mapped in the updated contexts: the learner engagement engine 330 re-aggregates activity differently per each context for product experiences to consume based on the remapped or newly updated contexts in real time.

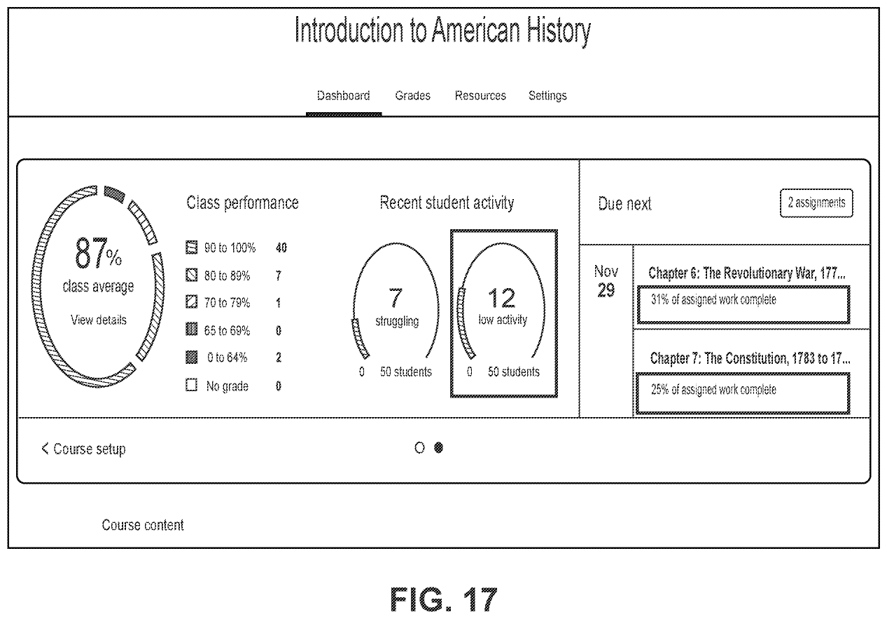

FIG. 17 illustrates a display that may be presented to a teacher, using a client device, to inform the teacher on various analytics regarding the students in the class. Learner engagement engine powering features in GLP Revel. Low activity indicator for GLP Revel may be used that alerts an instructor when a student has not completed 35% (business rule) or more of the assigned questions thereby empowering the instructor to intervene manually or via email with the given student or a set of students that have been classified as ‘Low Activity’. In some embodiments an indicator of a percentage of work completed for upcoming assignments may be used.

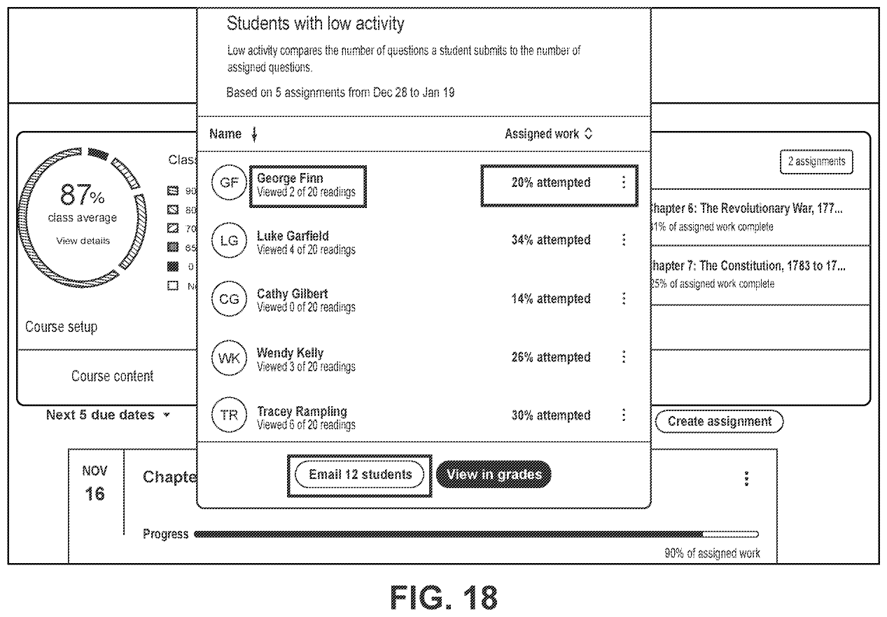

FIG. 18 illustrates a pop-up from the display in FIG. 28 that breaks the analytics down by student. Learner engagement engine powering features in GLP Revel may be used. As non-limiting examples, the amount of readings viewed per individual student, a percentage of work attempted by an individual student, a number of students and the total in ‘Low Activity’ may be monitored/measured. These measurements (or any other desired analytic herein described) may be used to email those students with some personalized intervention message.

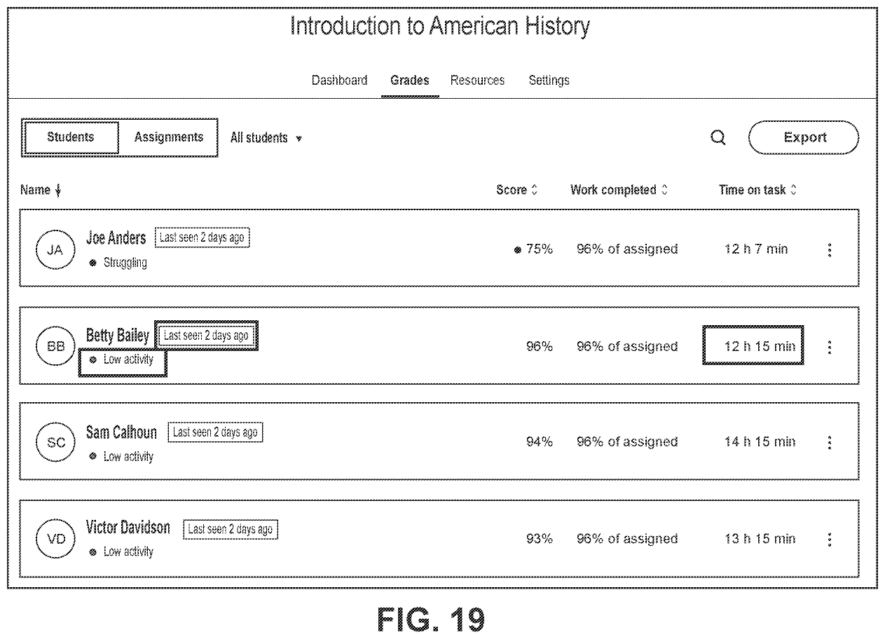

FIG. 19 illustrates a display that may be presented to a teacher, using a client device, to inform the teacher on the progress made by individual students. The learner engagement engine may power features in GLP Revel. A given assignment may be flagged as having a certain number of students who are considered to have low activity for the assessments in that assignment. The present invention may show the exact students for the given assignment that have low activity so instructors can intervene with them. The system may indicate the number of readings the student viewed for that assignment and/or indicate the percent of work the student has completed for the given assignment.

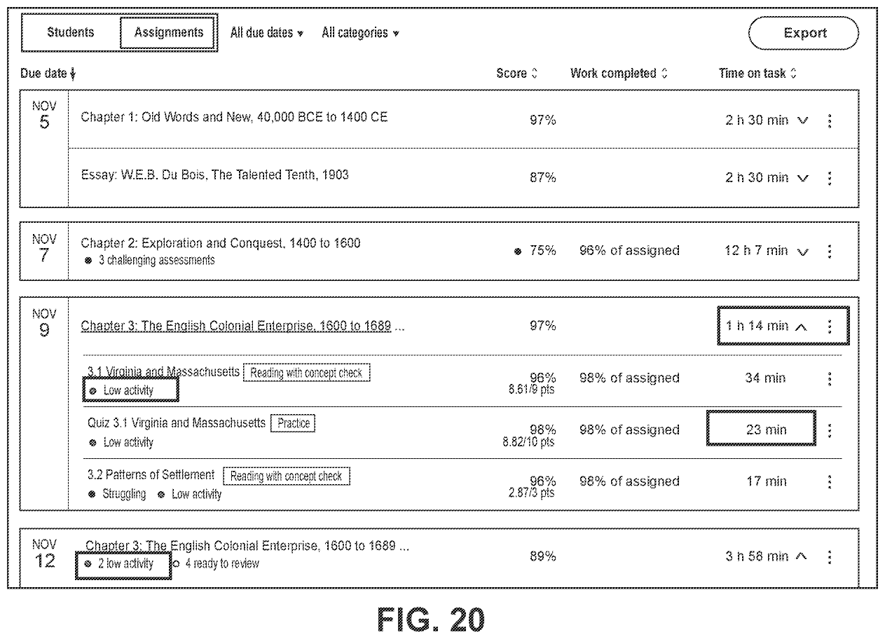

FIG. 20 illustrates a display that may be presented to a teacher, using a client device, to inform the teacher on the progress made on individual assignments. The graphical display illustrates a learner engagement engine powering features in GLP Revel. Also illustrated are a ‘Low activity’ indicator at the assignment level (contains multiple assessments) and ‘Low activity’ indicator at the assessment level (quiz of questions), time spent on average by the class on the given assignment and time spent on average by the class for each individual assessment or reading.

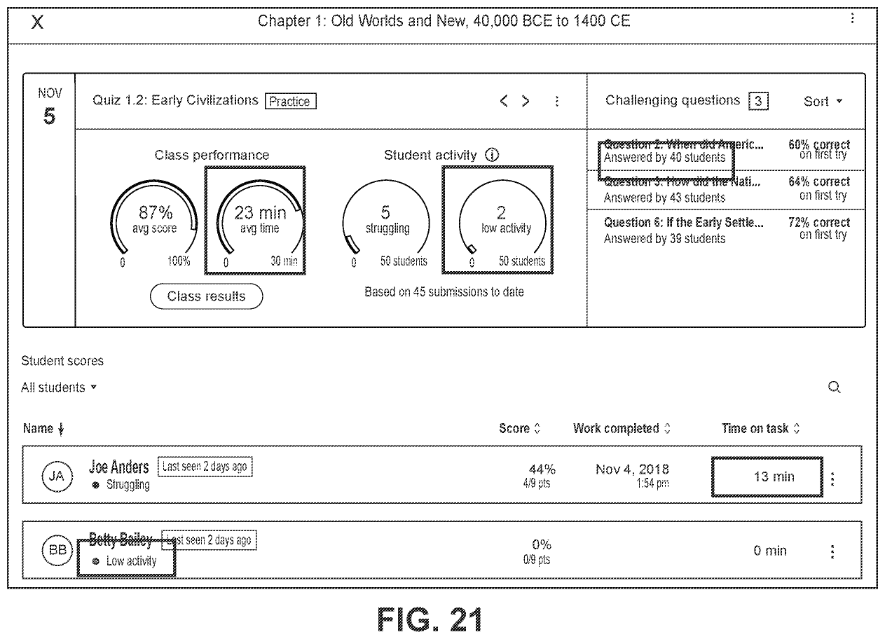

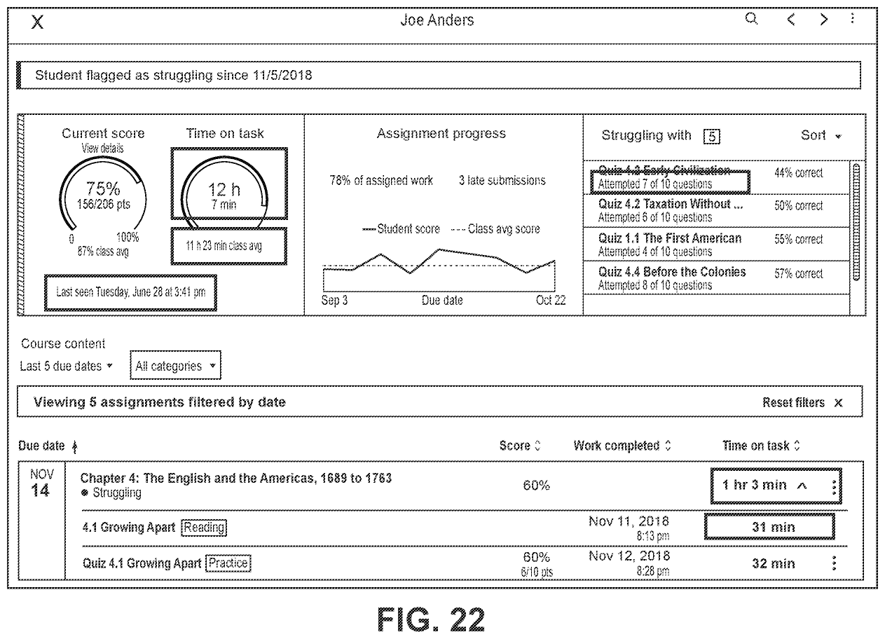

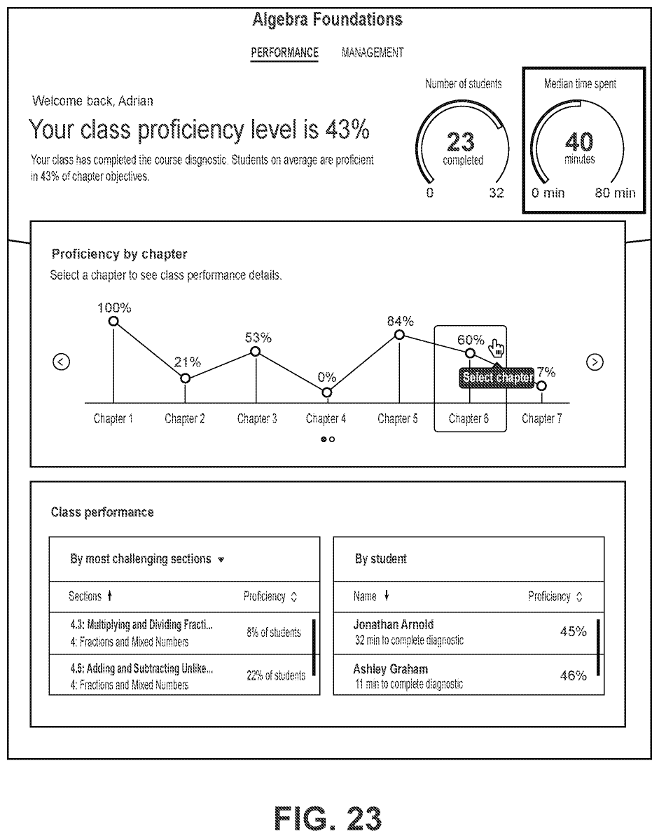

FIGS. 21-23 illustrates a display that may be presented to a teacher, using a client device, to inform the teacher on the progress made by the students in the class. FIG. 34 illustrates a display from the learner engagement engine that supports multiple models and graphically communicates a median time spent on a given assessment by class or total time spent on a given assessment by a given student.

Returning to FIGS. 16-17, another embodiment of the invention is a method for allowing analytics on measurements to work with an original table of contents (TOC) and with an updated TOC. An electronic education platform may generate an original TOC for the course. The electronic education platform comprises computer software and computer hardware (computer servers, routers, Internet connections and databases).

The original TOC, which may be a syllabus, provides a hierarchical structure for a course. The TOC comprises a plurality of assignments. Each assignment comprises one or more learning resources. Each learning resource may comprise three or more levels. As an example, a learning resource may be a book. The book may comprise the most generic level (name of the book), a middle tier level (a chapter title of the book) and a most detailed level (an image or a specific paragraph within the chapter of the book). The original TOC may be generated by any desired means by an instructor.

The hierarchical structure for a course may include, as non-limiting examples, a book, chapter, section, presentation, slide, image, question, question part, video, interactive, article, web page, dashboard, learning objectives and topic.

In a simplified example embodiment, the original TOC may comprise a first original assignment and a second original assignment. In this example, the first original assignment may comprise a first plurality of learning resources and the second original assignment may comprise a second plurality of learning resources.

In a preferred embodiment, the TOC may be updated at any time so that: 1) any learning resource in the first plurality of learning resources and the second plurality of learning resources may be deleted, 2) a new learning resource may be added to either the first plurality of learning resources or the second plurality of learning resources and/or 3) any learning resource (which may be referred to as a delta learning resource) may be interchanged between the first plurality of learning resources and the second plurality of learning resources.

A learning engagement engine may measure a plurality of student engagement activities for the first plurality of learning resources and the second plurality of learning resources. In a preferred embodiment, the learning resources are broken down several levels and measurements are for the most detailed level preselected for the learning resource. Measurements may be made by monitoring a student's activity online. Start times may be when a student downloads the material and stop time may be when a student changes to a different learning resources or disconnects from the learning resource. The dates that a student is engaged may be recorded. The number of times a student selects or interactives with learning resources may be monitored, recorded and saved. Comparisons between when a student started a project and when the project is due may also be measured and recorded. Average times for students to complete various portions of an assignment may also be calculated and graphically represented to the teacher. In some embodiments, idle time (when no student activity is detected) may be considered and removed from the various measurements as desired.

Of course, each learning resource will be unique and how many levels it is broken to may be selected based on what makes sense and will provide useful information to the instructor. Learning resources that are not broken down very far (such as only to a book level) will be easy for the system to track, but will not provide much information to the teacher regarding where in the book students may be having problems. Learning resources that are broken down too far (such as to a word level in a book) would be very difficult to track and would likely provide a lot of useless information to the teacher. Thus, depending on the course, students and learning resources, it will typically be desirable to break a book down to either a chapter level or, if the chapters have further breaks (such as perhaps images or questions), down to the breaks within a chapter.

Thus, if the learning resource is broken down to an image or paragraph level, then measurements are taken at an image or paragraph level by the learner engagement engine. If the learning resource is only broken down to a chapter level, then measurements are taken at the chapter level. If the learning resource is only broken down to a book level (typically the least desirable option mentioned), then measurements are taken at the book level.

The student engagement activities may be any desired activity that is wished to be measured by a student while engaged with a learning resource. As non-limiting examples, the student engagement activity may be time on task, resource views, last activities, comparatives, content usage, progression, learning sessions, engagement index, rankings, comprehension, objective time, focus, idle time, estimations and planning.

In an example embodiment, the learner engagement engine may aggregate the measurements in the plurality of student engagement activities that are in the first original assignment to determine a total amount of time spent on the first original assignment. Knowing how long each student was engaged with the learning resources in the first original assignment may be desirable for the teacher.

As an example, the first original assignment may be reading chapters 1, 2 and 3 in the book the Hobbit and the second original assignment may be reading chapter 4. If a student spent 1.1 hour reading chapter 1, 1.2 hours reading chapter 2 and 1.3 hours reading chapter 3, then the student would have spent 3.6 hours engaged on the first original assignment.

The learner engagement engine may also aggregate the measurements in the plurality of student engagement activities that are in the second original assignment. If the student spent 1.4 hours reading chapter 4, then the student would have spent 1.4 hours engaged with the second original assignment.

The learner engagement engine may graphically display any desired analytic that has been measured and determined. In the current example, the learner engagement engine may display the amount of time each student spent on the first original assignment and the amount of time each student spent on the second original assignment. In the above example, the student spent 3.6 hours on the first original assignment and 1.4 hours on the second original assignment.

As an example, the teacher may notice that an average time spent on the first assignment is significantly more than an average time spent on the second assignment (assuming the other students are similar to our example student). The teacher may desire that the average time spent for each assignment is more uniform.

As a specific example, the teacher using the electronic education platform may update the TOC so that a first updated assignment comprises reading chapters 1 and 2 in the book the Hobbit and a second updated assignment comprises reading chapters 3 and 4 in the book the Hobbit. Thus, in this example, chapter 3 (which may be referred to as the delta learning resource) was moved from the first original assignment to the second original assignment, thereby creating the first updated assignment (now without chapter 3) and the second updated assignment (now with chapter 3).

The teacher may desire to know the average time (or the time for a single student) that was spent on the first updated assignment and the average time for the second updated assignment, even though the students engaged the learning resources before the TOC was updated, i.e., when the chapters were arranged under different assignments. The learner engagement engine may aggregate the measurements of the plurality of student engagement activities that are in the first updated assignment (reading chapters 1 and 2) to determine a total amount of time spent by the student on the first updated assignment. The learning engagement engine may also aggregate the measurements of the plurality of student engagement activities that are in the second updated assignment (reading chapters 3 and 4) to determine a total amount of time spent by the student on the second updated assignment. Using the values from previous example, the total amount of time for the first updated assignment would be 2.3 hours and the total amount of time for the second updated assignment would be 2.7 hours. It should be appreciated that the measurements of the student engagement activities were taken when the students were working on the original TOC, even though the same measurements are now being used to analyze the new assignments in the updated TOC.

The learner engagement engine may now graphically display to the teacher using a client device the new metrics/analytics for the updated TOC using measurements taken when students were performing assignments defined by the original TOC.

In other embodiments, the learner engagement engine may send a text, email and/or message within the system to a teacher when a student is having problems as determined by a student being engaged below a preselected level (possibly selected by the teacher or a default level selected by the system). As an example, the system may detect that a student is reading for a far shorter time on average than other students in the class or is starting assignments much closer to a due date that other students. This may indicate for some students that they need an intervention or additional help to be successful. For other students this may indicate, if they are doing well on the assessments, that the student is not be challenged or learning as much as they could from the course. The teacher may wish to adjust the TOC if the course, based on the analytics, looks either too hard or too easy for the students.

In other embodiments, the learner engagement engine may look for past successful students (based on high assessment scores) and average one or more of their student engagement activities. As non-limiting examples, the learner engagement engine may aggregate how long past successful students took to perform an assignment and/or how long before an assignment was due the successful students started working on the assignments. Current students analytics may be compared to past successful student analytics and differences, over predefined limits, may be communicated to the teacher so that the teacher may intervene with the student. In other embodiments, student strategies (derived from the successful students) may be communicated to the teacher and/or any students that are deviating to far from the averages of the successful students.

The disclosed embodiments address three issues associated with learner engagement, including time spent accuracy, time spent loss, and engagement progression and completion. In other words At a high level, embodiments of the system that determine user activity and engagement based on loading and unloading present at least three issues that need to be solved in order to improve efficiency, including time spent accuracy, time spent loss accuracy, and engagement progression and completion. Non-limiting example scenarios may demonstrate these problems.

In some scenarios, a user may load a resource, but click within the UI on a resource unrelated to their current workload (e.g., YouTube, social media, etc.), thereby navigating away from the resource and therefore no longer engaged in the intended resource, class, etc. Even if it is related to their workload, it is impossible to know if it's related. Thus, the problem with the load/unload approach is that it only tracks the loading and unloading of resources.

The first issue is determining the accuracy of time of the learner spent engaged with the disclosed system, referred to herein as time spent accuracy. In the embodiments disclosed above, tracking a user's time spent engaged with the disclosed system is accomplished by capturing the timestamps of when an object loads and when it unloads. The disclosed system then calculates the span between those timestamps. This method assumes that between the load timestamp and the unload timestamp the learner is actively engaged, when in reality they may have stopped interacting with the page even though the page is still open or otherwise being accessed.

One problem with this approach is that human behaviors such as stepping away from the computer or shifting one's focus to a non-learning browser tab or activity conceptually stops the time spent learning process. Thus, in the embodiments disclosed below, a more accurate time spent provides instructors with more realistic learner insights in both their time spent and behaviors as well as provide more useful facts for research & personalization systems.

Thus, the most efficient approach may be to use time spent accuracy to identify a metric that tracks all user input as they are inputting it (e.g., scrolling, moving, checking things, clicking, hovering, etc.), in order to more accurately determine, using system logic, whether they're truly active or idle. Then, the system may identify patterns, record them, create templates and libraries, to more accurately determine learner engagement.

A second issue with the approach disclosed above includes a time spent loss. This time spent loss may be defined as the current implementation being limited in its approach in that it only calculates the time spent once an unload event is sent across multiple applications, possibly through a network. For scenarios where the unload event may be prevented from being sent through the network, the time spent by the learner will not be captured in its entirety. As non-limiting examples, such scenarios may include browser freezes and/or crashes, computer lockups, computer power outages, session timeouts etc., demonstrating time lost when the unload event does not fire. Capturing events in a stream of more frequent tracking and creating hooks into session management systems will minimize loss in these scenarios.

Thus, in some scenarios, the problem to solve is the time spent loss. For example, if a user closes a browser, there would be no unload event to determine the time spent in learner engagement. In other words, there would be a load event for a particular resource, but no matching unload event, making it impossible to determine how long a user was engaged. Other scenarios for time spent loss may include a session timeout, a closed browser, a computer crash, etc. What is needed is therefore a system that tracks, as efficiently as possible, real time and real activity types.

A third issue includes the limitation of tracking only the load and unload events against learning objects, referred to herein as engagement progression and completion, which prevents the system's ability to track progression and completion based on defined productive learning behaviors, thereby preventing the system from creating a more meaningful engagement score.

Tracking against loading, unloading and specific UI activities in the content allow the disclosed embodiments to define more valuable ‘completion’ and ‘progression’ events that are an aggregation of the actual clickstream activities that learners emit on learning objects.

The disclosed embodiments may include multiple features, such as real vs. feel time spent vs. idle. In some embodiments, the system may determine real time spent based on removing idle time. In some embodiments, the system may include a feature applying a feel time spent based on original approach of simple load/unload. In some embodiments, the system may Identify a difference between the two (e.g., load/unload vs. real time spent based on removing idle time), and comparing across learners may provide behavioral indicators. Some embodiments may include personalized planning. In some embodiments, the system may help students understand how much time it would take them to complete their assignment work based on past activity engagement data vs. the median or average time it takes for users.

Some embodiments may use a focus score. To accomplish this, the disclosed embodiments may establish a method to calculate (based on models and/or comparatives) whether or not the learner is productive and focused during their learning sessions (moving consistently through the content or jumping to non-content pages as a possible area of exploration).

Some embodiments may include anomaly detection, which may indicate a potential of cheating. As a non-limiting example, the system may detect patterns of behaviors, strings of specific events, or completion of unrealistic times, which may provide indicators to cheating algorithms (much the way that instructors sometimes use their instincts) plus time on task to detect cheating. This may be similar to credit card companies and their fraud detection where they pick up on specific usage patterns of newly stolen cards we may be able to detect patterns that indicate cheating.

Some embodiments may include a completion/progression pattern registry, library, & detection. In these embodiments, consumers can draw from default definitions or register specific definitions of ‘completion’ & ‘progress’ based upon content types and/or their own product model use cases. Using defined specific UI events (activity) on a given content combination and a specific defined order (sequence) can help to detect progression through the ‘session’ and/or completion that more closely reflects learning behavior or productive engagement as opposed to simple loading and unloading of content.

The following may be non-limiting examples of default content registrations: In one example, predefined registrations can be added to the system based on cross product model research of best practices. Examples might include: 1. ‘narrative_page’ entered as ‘shared’ in the registry and defined ‘completion’ as Completion=(Loads Page, Scrolls, Reaches at least 80% of page) and a progression assignment of Progression=(0.20, 0.20 0.60); or 2. ‘activity_page’ entered as ‘shared’ in the registry and defined ‘completion’ as Completion=(Loads Page, Clicks on Interactive, Scrolls, Reaches at least 80% of page) and a progression assignment of Progression=(0.20, 0.40, 0.20, 0.20)

The system may further include product consumer specific registrations. Non-limiting examples may include: 1. an eText reading page, wherein the consumer may register a definition specific to their product model (such as a narrative only page) like ‘etext_page_completion’ in the registry and define ‘completion’ as Completion=(Loads Page, Scrolls, Reaches Bottom of Page, Time>30 Seconds) and a progression assignment of Progression=(0.20, 0.30, 0.30, 0.20); 2. An Embedded Activity Page, wherein the consumer may register a definition specific to their product model (such as an activity embedded in a narrative page) like ‘embed_page_completion’ in the registry and define ‘completion’ as Completion=(Loads Page, Answers Question, Scrolls, Reaches Bottom of Page, Time>40 Seconds) and a progression assignment of Progression=(0.20, 0.50, 0.10, 0.10, 0.10); or 3. Video Segment Focus (a More complex example), wherein the consumer may register a definition specific to their product model (learner should at least watch the section on polynomials) like ‘cse_video_completion’ in the registry and define ‘completion’ as Completion=(Loads Video, Segment 1:10 sec-2:30 sec watched, min view 1×) and a progression assignment of Progression=(0.20, 0.80)

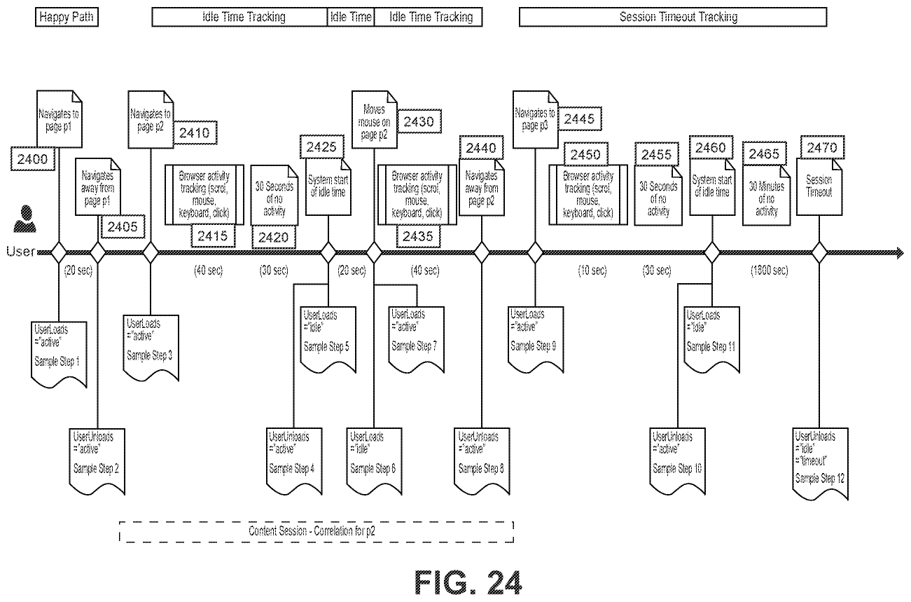

Referring now to FIG. 24, an idle time tracker is graphically illustrated to provide a distinction between time spent actively engaged in the content vs. time spent just having the content open. As described above, the disclosed system may track user interaction according to the user's access to various resources within the system, such as loading or unloading a particular resource. However, in some embodiments, the disclosed system may be configured to determine more granular interaction based on user input, or the lack thereof, using data related to user input/output devices, such as mouse input (e.g., clicking on an image within a section of a chapter in a book), keyboard input, navigating through the resources (e.g., scrolling through a section of a chapter), etc., and determine when the user is interacting with the system and when the user's interaction is idle. Thus, as seen in FIG. 24, an embodiment of the disclosed system may include one or more content session (correlation) software modules, that further include one or more idle time tracking software modules, and one or more session timeout tracking software modules. The content session software, the idle time tracking software and/or the session timeout tracking software may include a UserLoads variable or state, which may have an active and idle state, and a UserUnloads variable, which may have an active, idle, or timeout value and/or state.

In a non-limiting example embodiment, the content may be accessible via a website portal, which loads and/or navigates to one or more web pages that contain the content. The user may navigate to a page, P1, and the UserLoads variable may be set to active in step 2400. The user may interact with page P1 for 20 seconds, and may then navigate away from the page in step 2405, causing the UserUnloads variable for page P1 may be set to active. Continuing the example, the user may navigate to a second page, P2 in step 2410, and the UserLoads variable for page P2 may be set to active. In a simplified example, the user may spend 20 seconds on page P1, then navigate away from page P1 to page P2, and the the UserUnloads variable for page P1 may be set to to inactive. In this example, only the the UserLoads variable and the UserUnloads variable may be tracked. Using only these two variables, the system is unable to determine if the user is actively engaged with the loaded pages in step 2415, and is unable to track user movement to additional GUI or browser tabs, etc. In theory, these pages could be loaded and sit inactively.

In some embodiments, when the UserLoads variable is set to idle, the UserUnloads variable for page P2 may be set to active. Continuing the example, if the user provides mouse or keyboard input related to page P2 in step 2415, the UserLoads variable may be set to active, and in some embodiments, the UserUnloads variable for page P2 may be set to idle. At this point in the example, in some embodiments, one or more browser activity tracking software modules may be activated, which may track and indicate user interaction activity, such as mouse activity (e.g., scrolling, mouse clicks, keyboard input activity, etc.) in step 2415. This browser or other UI activity may include multiple UI events (possibly derived from HTML and/or JavaScript DOM UI events, such as scrolling, onmouseclick, onmouseover, playing a video through a browser, etc.). The system may therefore actively capture these UI events, such as scrolling through a page, moving the mouse, tapping a keyboard, tapping a screen, etc. In the non-limiting example in FIG. 24, the system may continue to register these UI events for about 40 seconds. By using such UI events, the disclosed system may distinguish between a loaded page in which nothing is happening (where the system may be idle or frozen, timed out, etc., in which the loaded page could be theoretically loaded forever), and a page on which the user is actively engaged. Continuing the example above, the user may provide such interaction for 40 seconds.

In step 2420, the system may store (possibly within the system logic or engagement profiles 300), a time interval representing a time during which there is no engagement with the UI. In the example in FIG. 24, this time interval may be set to 30 seconds. In some embodiments, this may be based on idle time patterns from previous user activity records (e.g., average for a user, average for a group of users such as a class, etc.). Using this time interval, the system may determine that an unload event should be fired, which disengages or unloads an active time, which indicates that the active time is unloaded and another event indicating idle time is loaded. Once activity resumes, idle time is unloaded, and the system again logs events from the UI. The disclosed system may then learn from the recorded data to determine more accurate time intervals to create models and other scenario data. Thus, in some embodiments, the system may specify a predetermined time interval (e.g., 30 seconds) of inactivity, during which no activity is detected by the system. In these embodiments, if the time interval completes (possibly according to threshold settings for the time interval), the UserLoads variable may be set to idle, and the system may mark the beginning of idle time for the user in step 2425.

The system may repeat this process in analogous steps 2430-2460, and in some embodiments, in steps 2465-2470, a timeout may be set for activity within the system. As a non-limiting example, if the timeout set for activity or inactivity is set to 30 minutes, if the disclosed system detects that 30 minutes of inactivity has passed, a session timeout may be recognized, and the UserUnloads variable for the relevant page may be set to idle, as well as timeout.

In some embodiments, the system may be configured to identify browser sessions, management sessions, etc. (30 minutes in FIG. 24). In some embodiments, such timeouts may be recognized as browser timeouts, session timeouts, system timeouts, etc., thereby recognizing, at both a browser or system level, when a user's device has been inactive for a predetermined period of time.

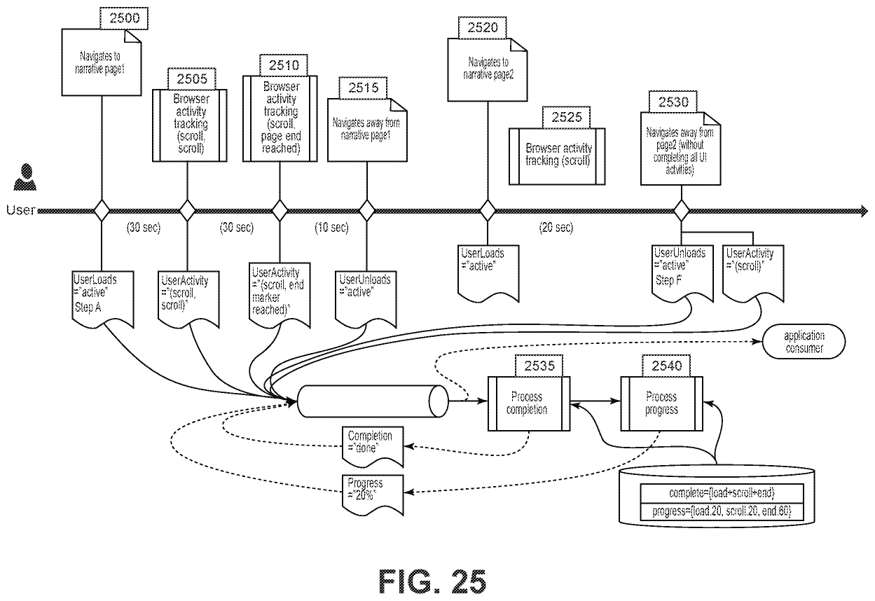

Embodiments such as that seen in FIG. 25 may determine process progress and process completion, similar to that described above. For example, in step 2500, a user may navigate to narrative page1, and the UserLoads variable state is set to active. In step 2505, browser activity tracking may detect that the user has scrolled, and a new variable state for UserActivity is set to (scroll, scroll). In step 2510, browser activity tracking may detect that a user has scrolled and reached the end of a page, and UserActivity is set to (scroll, end marker reached). In step 2515, a user may navigate away from narrative page1, and the UserUnloads variable state is set to active. The data for UserLoads UserUnloads and UserActivity may be processed as described above and called by consuming applications, as described above.

in step 2520, a user may navigate to narrative page2, and the UserLoads variable state is set to active. In step 2525, browser activity tracking may detect that the user has scrolled, and a new variable state for UserActivity is set to (scroll). However, in step 2530, the user may navigate away from narrative page2, without completing all UI activities. The data for UserLoads and UserActivity may again be processed as described above.

This data may be used to provide the system with process completion data and process progress data providing consumer applications with more accurate data. Using profile data, possibly from the engagement profiles 300, the system, possibly that described in more detail associated with FIG. 3, the system may analyze process completion 2535, and process progress 2540. For example, using the data from the examples above, as well as the appropriate profile data (complete=(load+scroll+end) and/or progress=(load.20, scroll.20, end.60)), the system may be able to determine that the Completion status=done, and Progress status=20%.

In some embodiments, the system may be configured to identify focus between tabs within the system, such as between browser tags, or selecting different active programs within the system. In these embodiments, the system may include various “listeners” that determine when a user has moved between various tabs or active programs. Based on the nature of the tab or program, the disclosed system may determine whether the user is active or idle.

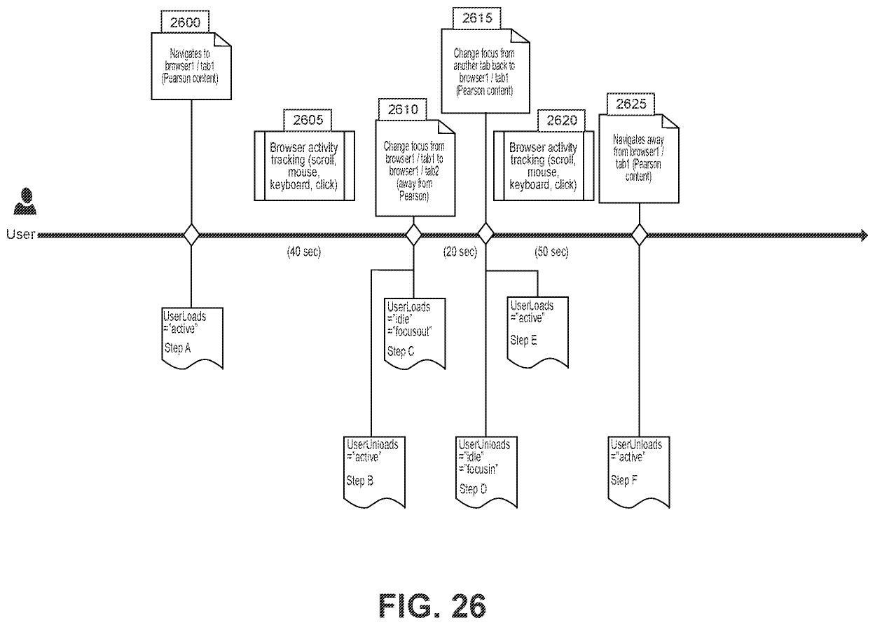

As a non-limiting example, in FIG. 26, in step 2600, a user may navigate to browser1/tab1, and the the UserLoads variable state is set to active. In step 2605, browser activity tracking may detect that the user has scrolled, used the mouse, used a keyboard, or clicked. In step 2610, the user may change focus from browser 1/tab 1 to browser 1/tab 2 (away from the focus of browser 1/tab 1) UserUnloads is set to active, and UserLoads is set to idle, focusout. In step 2515, the user changes focus from another tab back to browser 1/tab 1, and UserUnloads is set to idle, focusin, and UserLoads is set to active. In step 2620, browser activity tracking may detect that the user has scrolled, used the mouse, used a keyboard, or clicked, and in step 2625, the user may navigate away from browser 1/tab1 and UserUnloads is set to active.

In some embodiments, system logic, engagement profiles, or other stored data, may be used to determine more accurate ranges of times of activity or inactivity to determine when a user is actively engaged or is idle. This data may be used to determine specific recommendations for each user. For example, the data collected for a single student may be used to plan the time needed for a student to complete an assignment, and allocate a certain amount of of time based on past performance, and taking into consideration previous active and idle time, etc.

For example, the system could analyze various patterns for Student 1 to recommend to Student 1 that they need an hour and a half to complete an assignment based on an analysis of previous patterns (and therefore needs additional time), even though the average in the course only takes about 45 minutes,

As noted above, the disclosed system may include multiple Libraries and/or SDKs, which may be used to provide many variations in the functionality described herein, and may be used to customize this functionality to a particular software product, content, etc. In some embodiments, the system may select an engagement profile 300, allowing a certain set of rules to be applied in calculating idle time. As an example (if the timestamps indicate that there has been 20 seconds between start and stop then add 20 seconds to the user's time spent but if the start and stop indicates 45 seconds from one UI event to the next UI event and the profile indicates that a maximum of 30 seconds can be applied to time on task with the remaining time applied to idle time, then only add 30 seconds to the time spent and 15 seconds to the ‘idle’ time spent.

In another example, the system may be configured to store a specific time interval, during which it collects UI events. In the example above, the system may be configured to collect UI events and log them every 30 seconds. By doing so, the disclosed system may avoid losing data for a 5-minute interval where a page or other resource is loaded but never unloaded, since only 30 seconds of data would be lost during a 5 minute interval of inactivity (e.g., if the system or browser crashes, etc.).

In some embodiments, the libaraies/SDKs may contain instructions which cause the system to store the UI events in a queue every 30 seconds, and may pass this data to the input processing and messaging system 320, which may then parse and process the data in the queue, and separate idle time from active time. Over time, the disclosed system may use the logged data to generate a model, which, for example, may include an algorithm to define the time interval for individual students, classes, courses, etc. to identify idle time within the system.

In some embodiments, system logic and/or the engagement profiles may be configured to define parameters such as the time interval according to differences between running software applications, and/or software applications that access the disclosed system through an API, for example. As a non-limiting example, in these profiles based on software applications, the system may determine idle time and the associated time interval for a program that requires extensive user activity in a much shorter time interval than a program that only requires reading, and therefore may include intervals with less user activity.

In some embodiments, the log of user input data may be passed through an activity engagement processor 350, which may select an engagement profile. that will allow a certain set of rules to be applied in calculating idle time. As an example, if the timestamps indicate that there has been 20 seconds between start and stop then add 20 seconds to the user's time spent but if the start and stop indicates 45 seconds from one UI event to the next UI event and the profile indicates that a maximum of 30 seconds can be applied to time on task then only add 30 seconds to the time spent and 15 seconds to the ‘idle’ time spent.

In some embodiments, the system may process multiple messages by stringing together UI event start/stop timestamps in order to ensure not missing any events (in the scenario where the system events every 30 seconds). In some embodiments, the system may process the completion and progression update events based on reading in the definitions about productive engagement and calculating completion/progress from the UI activities strung together from logs. In some embodiments, the system may run the ‘Engagement Pipeline Pig’ on an hourly (frequency to be determined) interval to clean up any events that are still ‘open’. In some embodiments, as the EPP passes over the queue if the learner has not had an subsequent event in the queue over the last hour then process any engagement time in the remaining event, which may potentially apply a dynamic time spent based on a predicted estimate or personalized estimate.

The disclosed embodiments may have one or more default content registrations to choose from. As non-limiting examples, predefined registrations can be added to the system based on cross product model research of best practices. Examples might include: narrative_page entered as ‘shared’ in the registry and defined ‘completion’ as Completion=(Loads Page, Scrolls, Reaches at least 80% of page) and a progression assignment of Progression=(0.20, 0.20 0.60); or ‘activity_page’ entered as ‘shared’ in the registry and defined ‘completion’ as Completion=(Loads Page, Clicks on Interactive, Scrolls, Reaches at least 80% of page) and a progression assignment of Progression=(0.20, 0.40, 0.20, 0.20).

The disclosed embodiments may include product consumer specific registrations. In some embodiments this may include an eText Reading Page, in which a consumer may register a definition specific to their product model (such as a narrative only page) like ‘etext_page_completion’ in the registry and define ‘completion’ as Completion=(Loads Page, Scrolls, Reaches Bottom of Page, Time>30 Seconds) and a progression assignment of Progression=(0.20, 0.30, 0.30, 0.20).

The disclosed embodiments may include an embedded activity page, wherein the consumer may register a definition specific to their product model (such as an activity embedded in a narrative page) like ‘revel_embed_page_completion’ in the registry and define ‘completion’ as Completion=(Loads Page, Answers Question, Scrolls, Reaches Bottom of Page, Time>40 Seconds) and a progression assignment of Progression=(0.20, 0.50, 0.10, 0.10, 0.10).

In a more complex example, these embodiments may include a video segment focus, in which the consumer may register a definition specific to their product model (learner should at least watch the section on polynomials) like ‘cse_video_completion’ in the registry and define ‘completion’ as Completion=(Loads Video, Segment 1:10 sec-2:30 sec watched, min view 1×) and a progression assignment of Progression=(0.20, 0.80).

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method for allowing analytics on measurements to work with an original table of contents (TOC) and an updated TOC, comprising the steps of:
generating, by an electronic educational platform, the original TOC for a course,
wherein the original TOC comprises a first original assignment and a second original assignment,
wherein the first original assignment comprises a first plurality of learning resources and the second original assignment comprises a second plurality of learning resources, and
wherein the first plurality of learning resources comprises a delta learning resource;
measuring, by a learner engagement engine, a plurality of student engagement activities for the first plurality of learning resources and for the second plurality of learning resources;
aggregating, by the learner engagement engine, the measurements in the plurality of student engagement activities that are in the first original assignment to determine a total amount of time spent on the first original assignment;
aggregating, by the learner engagement engine, the measurements in the plurality of student engagement activities that are in the second original assignment to determine a total amount of time spent on the second original assignment;
graphically displaying, by the learner engagement engine, the total amount of time spent on the first original assignment and the total amount of time spent on the second original assignment;
generating, by the electronic education platform, the updated TOC,
wherein the delta learning resource is removed from the first original assignment to create a first updated assignment,
wherein the delta learning resource is added to the second original assignment to create a second updated assignment, and
wherein the plurality of student engagement activities were measured by the learning engagement engine before generating the updated TOC;
aggregating, by the learner engagement engine, the measurements in the plurality of student engagement activities that are in the first updated assignment to determine a total amount of time spent on the first updated assignment;
aggregating, by the learner engagement engine, the measurements in the plurality of student engagement activities that are in the second updated assignment to determine a total amount of time spent on the second updated assignment; and
graphically displaying, by the learner engagement engine, the total amount of time spent on the first updated assignment and the total amount of time spent on the second updated assignment.

2. The method of claim 1, wherein the first plurality of learning resources and the second plurality of learning resources each comprise a hierarchical structure comprising a most general level, a medium level and a most detailed level, and wherein the measured plurality of student engagement activities are for the most detailed level of the first plurality of learning resources and the most detailed level of the second plurality of learning resources.

3. The method of claim 1, further comprising the steps of:
storing, by a server comprising a computing device coupled to a network and comprising at least one processor executing instructions within a memory, in a database:
a content classified as a content type;
an engagement profile defining:
a content complete flag defining a user interaction with the content as complete; and
a time interval associated with the content type;
selecting, by the server, the content from the data store;
transmitting, by the server, the content to a client device coupled to the network;
receiving, from the client device:
at least one user input event associated with the content; and
an indication of a period of inactivity associated with the at least one user input event;
responsive to a determination that the at least one user input event has not triggered the content complete flag:
responsive to a determination that the period of inactivity is greater than the time interval associated with the content type, updating, by the server, a variable associated with the engagement profile, indicating that the at least one user input event is idle.

4. The method of claim 3, further comprising the steps of:
receiving, by the server, from the client device, the at least one user input event as a Document Object Model (DOM) event; and
storing, by the server, the DOM event in a user input event log.

5. the method of claim 3, further comprising the step of: responsive to a determination that the period of inactivity is greater than a second time interval stored in the database, removing, by the server, any of the at least one user input event associated with a user load variable that is not associated with a corresponding user unload variable.

6. The method of claim 5, wherein the period of inactivity is determined by a session timeout transmitted by a web browser or the server.

7. The method of claim 3, further comprising the step of identifying, by the server, from the at least one user input event, an accuracy of time spent engaged with the content.

8. The method of claim 3, further comprising the step of identifying, by the server, from the at least one user input event, a loss of time while engaged with the content.

9. The method of claim 3, further comprising the step of identifying, by the server, from the at least one user input event, a progression through, and completion of the content.

10. A system comprising a server comprising a computing device coupled to a network and comprising at least one processor executing instruction within memory which, when executed, cause the system to:
generate, by an electronic educational platform, an original table of contents (TOC) for a course,
wherein the original TOC comprises a first original assignment and a second original assignment,
wherein the first original assignment comprises a first plurality of learning resources and the second original assignment comprises a second plurality of learning resources, and
wherein the first plurality of learning resources comprises a delta learning resource;
measure, by a learner engagement engine, a plurality of student engagement activities for the first plurality of learning resources and for the second plurality of learning resources;
aggregate, by the learner engagement engine, the measurements in the plurality of student engagement activities that are in the first original assignment to determine a total amount of time spent on the first original assignment;
aggregate, by the learner engagement engine, the measurements in the plurality of student engagement activities that are in the second original assignment to determine a total amount of time spent on the second original assignment;
graphically display, by the learner engagement engine, the total amount of time spent on the first original assignment and the total amount of time spent on the second original assignment;
generate, by the electronic education platform, an updated TOC,
wherein the delta learning resource is removed from the first original assignment to create a first updated assignment,
wherein the delta learning resource is added to the second original assignment to create a second updated assignment, and
wherein the plurality of student engagement activities were measured by the learning engagement engine before generating the updated TOC;
aggregate, by the learner engagement engine, the measurements in the plurality of student engagement activities that are in the first updated assignment to determine a total amount of time spent on the first updated assignment;
aggregate, by the learner engagement engine, the measurements in the plurality of student engagement activities that are in the second updated assignment to determine a total amount of time spent on the second updated assignment; and
graphically display, by the learner engagement engine, the total amount of time spent on the first updated assignment and the total amount of time spent on the second updated assignment.

11. The system of claim 10, wherein the first plurality of learning resources and the second plurality of learning resources each comprise a hierarchical structure comprising a most general level, a medium level and a most detailed level, and wherein the measured plurality of student engagement activities are for the most detailed level of the first plurality of learning resources and the most detailed level of the second plurality of learning resources.

12. The system of claim 10, wherein the instructions further cause the system to:
store, in a data store:
a content classified as a content type;
an engagement profile defining:
a content complete flag defining a user interaction with the content as complete; and
a time interval associated with the content type;
select the content from the data store;
transmit the content to a client device coupled to the network;
receive, from the client device:
at least one user input event associated with the content; and
an indication of a period of inactivity associated with the at least one user input event;
responsive to a determination that the at least one user input event has not triggered the content complete flag:
responsive to a determination that the period of inactivity is greater than the time interval associated with the content type, update a variable associated with the engagement profile, indicating that the at least one user input event is idle.

13. The system of claim 12, wherein the instructions further cause the system to:
receive, from the client device, the at least one user input event as a Document Object Model (DOM) event; and
store the DOM event in a user input event log.

14. the system of claim 12, wherein the instructions further cause the system to: responsive to a determination that the period of inactivity is greater than a second time interval stored in the database, remove any of the at least one user input event associated with a user load variable that is not associated with a corresponding user unload variable.

15. The system of claim 14, wherein the period of inactivity is determined by a session timeout transmitted by a web browser or the server.

16. The method of claim 12, wherein the instructions further cause the system to identify, from the at least one user input event, an accuracy of time spent engaged with the content.

17. The system of claim 12, wherein the instructions further cause the system to identify, from the at least one user input event, a loss of time while engaged with the content.

18. The system of claim 12, wherein the instructions further cause the system to identify, from the at least one user input event, a progression through, and completion of the content.
